(19) United States
(12) Patent Application Publication
(10) Pub. No.: US 2026/0167343 A1
(43) Pub. Date: Jun. 18, 2026

(54) THERMAL MANAGEMENT APPARATUS AND METHOD FOR ELECTRIC PROPULSION AIRCRAFT

(71) Applicant: KOREA AEROSPACE RESEARCH INSTITUTE, Daejeon (KR)

(72) Inventors: Byeung Jun LIM, Daejeon (KR); Sangyoon LEE, Daejeon (KR); Sangook JUN, Daejeon (KR); Jae Sung HUH, Daejeon (KR); Poomin PARK, Daejeon (KR)

(21) Appl. No.: 19/411,989

(22) Filed: Dec. 8, 2025

(30) Foreign Application Priority Data
Dec. 12, 2024 (KR) 10-2024-0185071
Dec. 19, 2024 (KR) 10-2024-0191715
Dec. 19, 2024 (KR) 10-2024-0191716

(51) Int. Cl. B64D 33/08; B64D 27/33; F02C 7/16

(52) U.S. Cl. CPC B64D 33/08; B64D 27/33; F02C 7/16; F05D 2220/323; F05D 2260/213

(57) ABSTRACT

A thermal management apparatus for an electric propulsion aircraft includes a first cooling channel configured to receive heat from a first cooling target component, a second cooling channel configured to receive heat from a second cooling target component, a heat exchanger in which a first cooling fluid having passed through the first cooling channel and the second cooling channel exchanges heat with outside air, and a first additional cooling unit configured to supply a second cooling fluid to the first cooling target component and the second cooling target component, wherein in a first situation, the first cooling fluid and the second cooling fluid cool the first cooling target component and the second cooling target component together.

### CROSS-REFERENCE TO RELATED APPLICATIONS

This application is based on and claims priority under 35 U.S.C. § 119 to Korean Patent Application No. 10-2024-0185071, filed on Dec. 12, 2024, Korean Patent Application No. 10-2024-0191715, filed on Dec. 19, 2024, and Korean Patent Application No. 10-2024-0191716, filed on Dec. 19, 2024, in the Korean Intellectual Property Office, the disclosures of which are incorporated by reference herein in their entirety.

### BACKGROUND

### 1. Field

The disclosure relates to a thermal management apparatus and method for an electric propulsion aircraft.

### 2. Description of the Related Art

Recently, an electric vertical take-off and landing (eVTOL) aircraft has been spotlighted as urban air mobility (UAM) or advanced air mobility (AAM). The eVTOL aircraft is a vertical take-off and landing aircraft that uses electric energy as a power source. The eVTOL aircraft may include a hybrid type that uses, as a power source, not only electric energy stored in a battery but also electric energy produced by the operation of a gas turbine.

Because a motor and an inverter, which are main components for proving power to the eVTOL aircraft, are heated during an energy conversion process, it may be important to cool electrical components thereof for continuous system operation. Moreover, the eVTOL aircraft uses maximum power during take-off or landing and uses significantly less power during cruise. In the related art, because a cooling system for electrical components of an eVTOL aircraft is designed based on the maximum power during take-off or landing, the size of the cooling system is excessive compared to that during cruise. Moreover, the weight and volume of the cooling system designed based on the maximum power hinder the aircraft performance.

Information described in this Background section was already known to the inventors before achieving the disclosure or is technical information acquired in the process of achieving the disclosure; therefore, it may contain information that does not form the prior art that is already known to the public.

### SUMMARY

In order to solve the above problem, the disclosure provides a thermal management apparatus and method for an electric propulsion aircraft, which may reduce the weight and volume of a cooling unit and improve the performance of a heat exchanger by including an additional cooling unit.

However, these problems are merely examples, and the problems to be solved by the disclosure are not limited thereto. Other problems not mentioned herein will be clearly understood by those of ordinary skill in the art from the specification and the accompanying drawings.

Additional aspects will be set forth in part in the description which follows and, in part, will be apparent from the description, or may be learned by practice of the presented embodiments of the disclosure.

According to an aspect of the disclosure, a thermal management apparatus for an electric propulsion aircraft includes a first cooling channel configured to receive heat from a first cooling target component, a second cooling channel configured to receive heat from a second cooling target component, a heat exchanger in which a first cooling fluid having passed through the first cooling channel and the second cooling channel exchanges heat with outside air, and a first additional cooling unit configured to supply a second cooling fluid to the first cooling target component and the second cooling target component, wherein in a first situation, the first cooling fluid and the second cooling fluid cool the first cooling target component and the second cooling target component together.

The first additional cooling unit may include a cooling cartridge configured to supply a second cooling fluid to the first cooling target component or the second cooling target component, a first supply path which includes one end connected to the cooling cartridge and another end facing the first cooling target component and through which the second cooling fluid flows, and a second supply path which includes one end connected to the cooling cartridge and another end facing the second cooling target component and through which the second cooling fluid flows.

The thermal management apparatus may further include a controller configured to control an operation of the thermal management apparatus, a first opening/closing unit arranged on the first supply path, and a second opening/closing unit arranged on the second supply path, wherein the controller may control flow of the second cooling fluid by operating the first opening/closing unit and the second opening/closing unit.

The first additional cooling unit may include a recovery cartridge into which the second cooling fluid having passed through the first cooling target component or the second cooling target component is introduced and stored.

According to another aspect of the disclosure, a thermal management apparatus for an electric propulsion aircraft includes a first cooling channel configured to receive heat from a first cooling target component, a second cooling channel configured to receive heat from a second cooling target component, a heat exchanger in which a first cooling fluid having passed through the first cooling channel and the second cooling channel exchanges heat with outside air, and a second additional cooling unit configured to supply a third cooling fluid to the first cooling target component and the second cooling target component, wherein in a first situation, the first cooling fluid and the third cooling fluid cool the first cooling target component and the second cooling target component together, the second additional cooling unit is between a gas turbine engine and a fuel tank, and the third cooling fluid includes fuel used in the gas turbine engine.

The second additional cooling unit may include a power generation flow path which includes one end connected to the fuel tank and another end connected to the gas turbine engine and through which the third cooling fluid flows, and an additional cooling flow path which includes one end connected to the fuel tank and another end facing the first cooling target component and the second cooling target component and through which the third cooling fluid flows.

The thermal management apparatus may further include a controller configured to control an operation of the thermal management apparatus, a third opening/closing unit arranged on the power generation flow path, and a fourth opening/closing unit arranged on the additional cooling flow path, wherein the controller controls flow of the third cooling fluid by operating the third opening/closing unit and the fourth opening/closing unit.

The thermal management apparatus may further include a first additional cooling unit configured to supply a second cooling fluid to the first cooling target component and the second cooling target component, wherein in the first situation, the first cooling fluid, the second cooling fluid, and the third cooling fluid together may cool the first cooling target component and the second cooling target component together, and in a second situation, only the first cooling fluid may cool the first cooling target component and the second cooling target component.

According to another aspect of the disclosure, a thermal management apparatus for an electric propulsion aircraft includes an air inhalation port configured to inhale air outside the electric propulsion aircraft into an inside thereof, a first heat exchanger in which hydrogen supplied from a hydrogen tank and air supplied from the air inhalation port exchange heat with each other and which supplies, to a hydrogen using unit, hydrogen having completed heat exchange, a cooling channel configured to receive heat from an electrical component, and a second heat exchanger in which a first cooling fluid having passed through the cooling channel and air having completed heat exchange in the first heat exchanger exchange heat with each other.

The thermal management apparatus may further include an air temperature measurement unit configured to measure an air temperature outside the electric propulsion aircraft.

The thermal management apparatus may further include a component temperature measurement unit configured to measure a temperature of the electrical component.

The thermal management apparatus may further include a first additional cooling unit configured to cool the electrical component by using a second cooling fluid.

The thermal management apparatus may further include a second additional cooling unit configured to cool the electrical component by using a third cooling fluid, wherein the second additional cooling unit may be between a gas turbine engine and a fuel tank, and the third cooling fluid may include fuel used in the gas turbine engine.

According to another aspect of the disclosure, a thermal management apparatus for an electric propulsion aircraft includes a cooling channel configured to receive heat from an electrical component, a heat exchanger in which a first cooling fluid having passed through the cooling channel exchanges heat with outside air, an air inhalation port configured to inhale the outside air into an inside thereof and transmit the inhaled outside air to the heat exchanger, and a dry ice cartridge which is arranged between the heat exchanger and the air inhalation port and through which air introduced through the air inhalation port passes.

The thermal management apparatus may further include a cooling fluid temperature measurement unit configured to measure a temperature of a cooling fluid flowing through a cooling fluid circulation path connected to the heat exchanger.

The thermal management apparatus may further include an air temperature measurement unit configured to measure an air temperature outside the electric propulsion aircraft.

The thermal management apparatus may further include a first additional cooling unit configured to cool the electrical component by using a second cooling fluid.

The thermal management apparatus may further include a second additional cooling unit configured to cool the electrical component by using a third cooling fluid, wherein the second additional cooling unit may be between a gas turbine engine and a fuel tank, and the third cooling fluid may include fuel used in the gas turbine engine.

The heat exchanger may include a first heat exchanger in which hydrogen supplied from a hydrogen tank and air supplied from the air inhalation port exchange heat with each other and which supplies, to a hydrogen using unit, hydrogen having completed heat exchange, and a second heat exchanger in which a first cooling fluid having passed through the cooling channel and air having completed heat exchange in the first heat exchanger exchange heat with each other.

Other aspects, features, and advantages other than those described above will become apparent from the following detailed description, the appended claims, and the accompanying drawings.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an electric propulsion aircraft according to embodiments;

FIG. 2 is a conceptual diagram schematically illustrating a thermal management apparatus for an electric propulsion aircraft according to an embodiment;

FIG. 3 illustrates connections between particular components of the thermal management apparatus of FIG. 2;

FIG. 4 illustrates an example in which a cooling unit independently cools a first cooling target component and a second cooling target component, according to embodiments;

FIG. 5 illustrates an example in which a first additional cooling unit independently cools a first cooling target component and a second cooling target component, according to an embodiment;

FIG. 6 illustrates an electric propulsion aircraft including a recovery cartridge according to an embodiment;

FIG. 7 illustrates a main operation period of a first additional cooling unit from take-off to landing of an electric propulsion aircraft according to embodiments;

FIG. 8 is a flowchart illustrating a thermal management method for an electric propulsion aircraft according to another embodiment;

FIG. 9 particularly illustrates an operation of controlling flow of a second cooling fluid;

FIG. 10 is a conceptual diagram schematically illustrating a thermal management apparatus for an electric propulsion aircraft according to another embodiment;

FIG. 11 illustrates connections between particular components of the thermal management apparatus of FIG. 10;

FIG. 12 is a flowchart illustrating a thermal management method for an electric propulsion aircraft according to another embodiment;

FIG. 13 particularly illustrates an operation of controlling flow of a third cooling fluid;

FIG. 14 is a conceptual diagram schematically illustrating a thermal management apparatus for an electric propulsion aircraft according to another embodiment;

FIG. 15 illustrates connections between particular components of the thermal management apparatus of FIG. 14;

FIG. 16 is a conceptual diagram schematically illustrating a thermal management apparatus for an electric propulsion aircraft according to another embodiment;

FIG. 17 illustrates connections between particular components of the thermal management apparatus of FIG. 16;

FIG. 18 illustrates an example in which a cooling unit independently cools a first cooling target component and a second cooling target component, according to embodiments;

FIG. 19 is a flowchart illustrating a thermal management method for an electric propulsion aircraft according to another embodiment;

FIG. 20 is a conceptual diagram schematically illustrating a thermal management apparatus for an electric propulsion aircraft according to another embodiment;

FIG. 21 illustrates connections between particular components of the thermal management apparatus of FIG. 20;

FIG. 22 is a flowchart illustrating operations that may be added to the thermal management method of FIG. 19 when a thermal management apparatus for an electric propulsion aircraft includes a first additional cooling unit;

FIG. 23 is a conceptual diagram schematically illustrating a thermal management apparatus for an electric propulsion aircraft according to another embodiment;

FIG. 24 illustrates connections between particular components of the thermal management apparatus of FIG. 23;

FIG. 25 is a flowchart illustrating operations that may be added to the thermal management method of FIG. 19 when a thermal management apparatus for an electric propulsion aircraft includes a second additional cooling unit;

FIG. 26 is a conceptual diagram schematically illustrating a thermal management apparatus for an electric propulsion aircraft according to another embodiment;

FIG. 27 illustrates connections between particular components of the thermal management apparatus of FIG. 26;

FIG. 28 illustrates connections between particular components of a thermal management apparatus according to another embodiment;

FIG. 29 illustrates a schematic shape of a dry ice cartridge unit according to embodiments;

FIG. 30 illustrates a controller according to an embodiment;

FIG. 31 illustrates a dry ice cartridge transfer process according to embodiments;

FIG. 32 is a graph schematically illustrating a state in which the dry ice weight, the thermal management apparatus power consumption, the cooling fluid pump output, and the fan output decrease over the operation time of a thermal management apparatus for an electric propulsion aircraft according to another embodiment;

FIG. 33 is a flowchart illustrating a thermal management method for an electric propulsion aircraft according to another embodiment; and

FIGS. 34 to 40 schematically illustrate a flow of a fluid in a thermal management apparatus for an electric propulsion aircraft according to embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Embodiments may be understood by reference to the description of the disclosure and the accompanying drawings. Described embodiments may have various modifications and may be implemented in different forms, and the scope of the disclosure is not limited to the embodiments described herein. Also, the respective features of various embodiments may be combined in part or in whole. Embodiments may be implemented independently or in conjunction with each other. The described embodiments are provided as examples such that the disclosure may be complete and thorough, and are intended to fully convey the spirit of the disclosure to those of ordinary skill in the art. The disclosure may encompass all modifications, equivalents, and substitutions within the spirit and scope of the disclosure. Thus, processes, elements, and techniques not necessary for those of ordinary skill in the art to fully understand the embodiments may not be described.

Like reference numerals, letters, or combinations thereof denote like elements throughout the accompanying drawings and the specification unless otherwise specified, and thus, redundant descriptions will be omitted for conciseness. Also, in order to clearly describe the disclosure, descriptions irrelevant to the disclosure may be omitted for conciseness.

In the accompanying drawings, the relative sizes of elements, layers, and regions may be exaggerated for clarity. In the accompanying drawings, hatching and/or shading may be generally used to clarify the boundary between adjacent elements. Thus, the presence or absence of hatching or shading may not imply a desired form or requirement for a particular material, material property, dimension, proportion, commonality between elements, and/or a feature, property, or attribute of any element.

Various embodiments will be described herein with reference to cross-sectional illustrations that are schematic illustrations of embodiments and/or intermediate structures. Thus, the shapes of the drawings may vary, for example, as a result of manufacturing technology and/or tolerance. Also, particular structural or functional descriptions given herein are merely examples for describing embodiments according to the concept of the disclosure. Thus, the embodiments described herein should not be construed as being limited to the shapes of regions illustrated and may include, for example, variations of shapes due to manufacturing.

The regions illustrated in the drawings are schematic in nature, and their shapes are not intended to illustrate the actual shapes of device regions and are not intended to limit the scope of the disclosure. Also, as will be appreciated by those of ordinary skill in the art, the described embodiments may be modified in various ways without departing from the spirit or scope of the disclosure.

A number of particular details are presented herein to provide a thorough understanding of various embodiments. However, various embodiments may be implemented without these particular details or with one or more details. In other cases, well-known structures and devices are illustrated in the form of block diagrams to avoid unnecessarily obscuring various embodiments.

For convenience of description, spatially relative terms such as “under”, “over”, “lower”, and “upper” may be used herein to describe the relationship between an element or feature and another element or feature as illustrated in the drawings. Spatially relative terms may be intended to encompass various directions of a device in use or operation, in addition to the directions illustrated in the drawings. For example, when a device in the drawings is turned over, another element or feature described as “under” or “lower” faces “over” or “upper” of the other element or feature. Thus, for example, the terms “under” and “lower” may encompass both the “over” and “under” directions. The device may face in another direction (e.g., rotated by 90 degrees or in another direction), and the spatially relative descriptions used herein should be interpreted accordingly. Likewise, when a first element is referred to as being arranged “over” a second element, it may mean that the first element is arranged over or under the second element.

Also, the expression “in a plan view” may mean the case where an object is viewed from above, and the expression “in a schematic cross-sectional view” may mean the case where a schematic cross-sectional view is taken by cutting an object vertically. The expression “in a side view” may mean that a first object may be on an upper, lower, or side surface of a second object, or vice versa. Additionally, the term “overlapping” or “superimposing” may include the term “layer”, “stacking”, “surface”, “extending”, “covering”, or “partially covering” or any other suitable term that may be understood by those of ordinary skill in the art. The expression “non-overlapping” may include the expression “apart from” or “spaced apart from” and any other suitable equivalents appreciated and understood by those of ordinary skill in the art. The terms “side” and “surface” may mean that a first object may directly or indirectly face a second object. When a third object is between a first object and a second object, the first object and the second object may be understood as indirectly facing each other.

When an element, layer, region, or component is referred to as being “formed on”, “connected to”, or “coupled to” another element, layer, region, or component, it may be directly formed on, connected to, or coupled to the other element, layer, region, or component or may be indirectly formed on, connected to, or coupled to the other element, layer, region, or component. Also, “formed on”, “connected to”, or “coupled to” may collectively refer to direct or indirect coupling or connection or integral or non-integral coupling or connection between elements, layers, regions, or components such that one or more elements, layers, regions, or components may be present. For example, when an element, layer, region, or component is referred to as being “electrically connected to” or “electrically coupled to” another element, layer, region, or component, it may be directly electrically connected to or coupled to the other element, layer, region, or component or may be indirectly electrically connected to or coupled to the other element, layer, region, or component with one or more other elements, layers, regions, or components therebetween. However, “direct connection” or “direct coupling” may mean that a component is directly connected or coupled to or is directly on another component without an intermediate component therebetween. Also, herein, when an element such as a layer, a film, a region, or a guide plate is referred to as being formed on another element, the direction of formation is not limited to the upper direction and the element may also be formed on a side surface or lower surface of the other element. Conversely, when an element such as a layer, a film, a region, or a guide plate is referred to as being formed “under” another element, the element may be “directly under” the other element or may be “indirectly under” the other element with one or more intervening elements therebetween. Moreover, other expressions such as “between”, “directly between”, “adjacent to”, and “directly adjacent to” describing the relationship between components may be similarly interpreted. Also, when an element or layer is referred to as being “between” two elements or layers, it may be the only element between the two elements or layers or there may be one or more other elements therebetween.

For the purpose of the specification, the expression such as “at least one of” or “any one of” do not limit the order of individual elements. For example, the expression “at least one of X, Y, and Z”, “at least one of X, Y, or Z”, or “at least one selected from the group consisting of X, Y, and Z” may include X alone, Y alone, Z alone, or any combination of two or more of X, Y, and Z. Similarly, the expression such as “at least one of A and B” or “at least one of A or B” may include A, B, or A and B. Generally, herein, the term “and/or” may include any and all combinations of one or more of the associated listed items. For example, the expression “A and/or B” may include A, B, or A and B.

Although terms such as “first”, “second”, and “third” may be used herein to describe various elements, components, regions, layers, and/or cross-sections, these elements, components, regions, layers, and/or cross-sections are not limited by these terms. These terms are only used to distinguish an element, component, region, layer, or cross-section from another element, component, region, layer, or cross-section. Thus, a first element, component, region, layer, or cross-section described below may be referred to as a second element, component, region, layer, or cross-section without departing from the spirit and scope of the disclosure. Describing an element as a “first” element may not require or imply the presence of a second element or other elements. Terms such as “first” and “second” may also be used herein to distinguish different categories or element sets. For clarity, the terms “first” and “second” may respectively represent a “first category (or first set)” and a “second category (or second set)”.

The terminology used herein is for the purpose of describing particular embodiments only and is not intended to limit the disclosure. As used herein, the singular forms “a,” “an” and “the” are intended to include the plural forms as well and vice versa, unless the context clearly indicates otherwise. The terms “comprise”, “include”, and “have”, when used herein, specify the presence of stated functions, features, integers, steps, operations, elements, and/or components. These terms do not preclude the presence or addition of one or more other functions, features, integers, steps, operations, elements, components, and/or groups thereof.

When one or more embodiments may be implemented differently, a particular process order may be performed differently from the described order. For example, two processes described in succession may be performed substantially at the same time or may be performed in an order opposite to the described order.

The terms “substantially”, “about”, and “approximately” and similar terms may be used as terms of approximation rather than terms of degree and may mean satisfying the inherent variation range of measured or calculated values (e.g., the variation range due to the limitation of the measurement system). For example, “about” may mean within one or more standard deviations or within +30%, 20%, 10%, or 5% of a stated value.

Unless otherwise defined, all terms (including technical and scientific terms) used herein may have the same meanings as commonly understood by those of ordinary skill in the art to which the disclosure belongs. Terms such as those defined in commonly used dictionaries should be interpreted as having a meaning that is consistent with their meaning in the context of the relevant art and will not be interpreted in an idealized or overly formal sense unless expressly so defined herein.

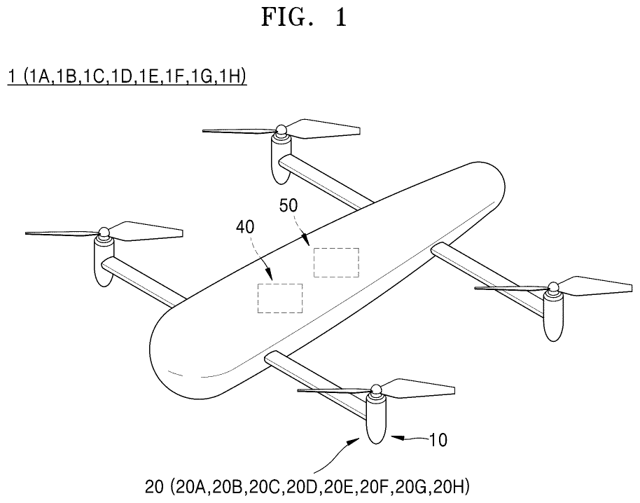

Hereinafter, a thermal management apparatus and method for an electric propulsion aircraft according to embodiments will be described with reference to FIGS. 1 to 40.

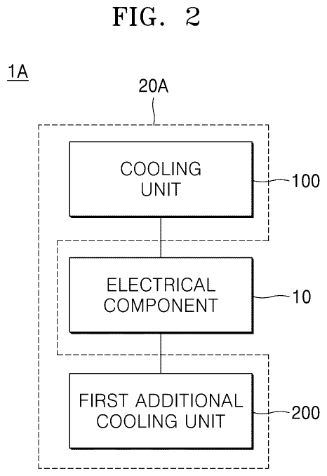

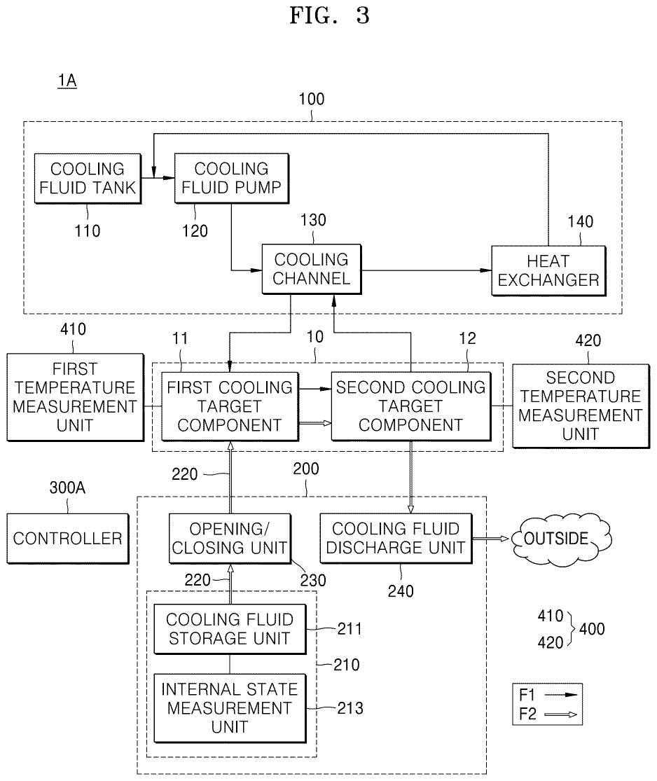

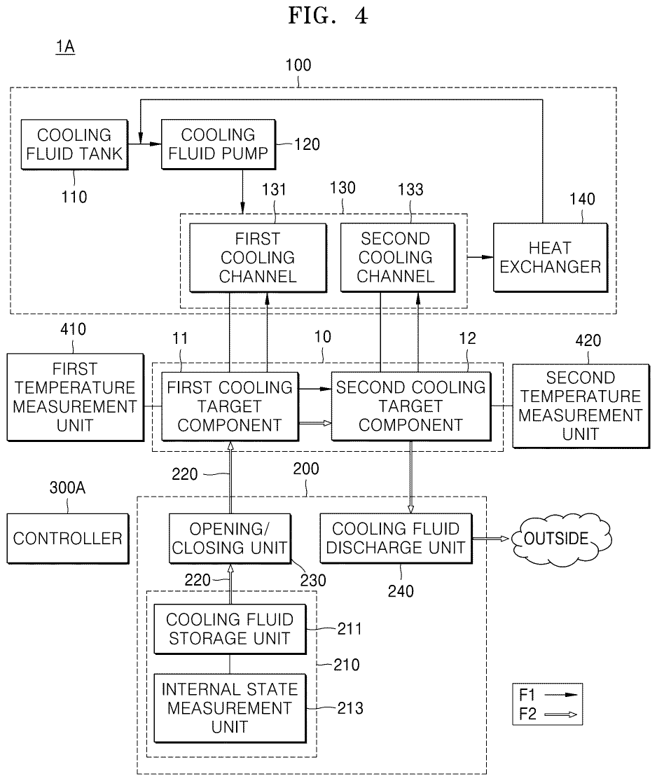

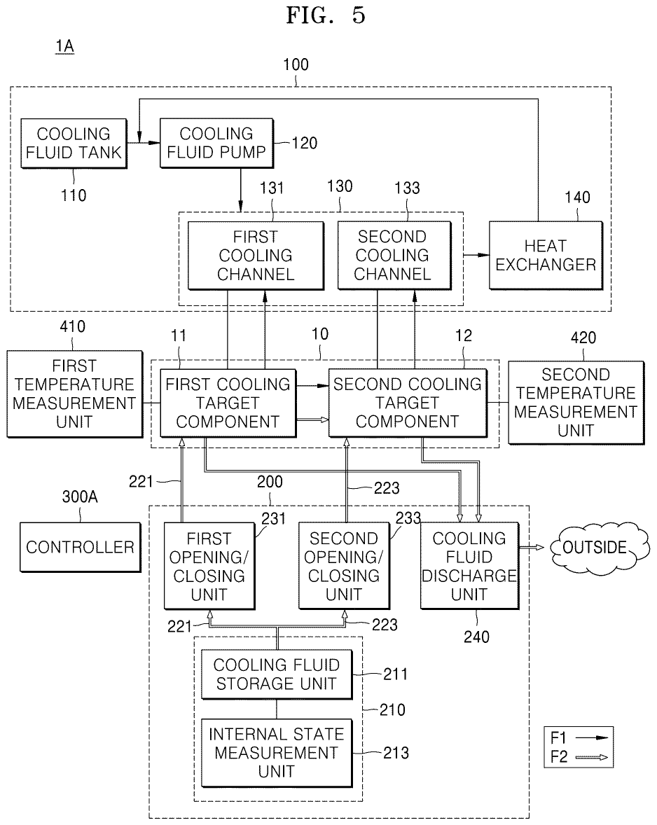

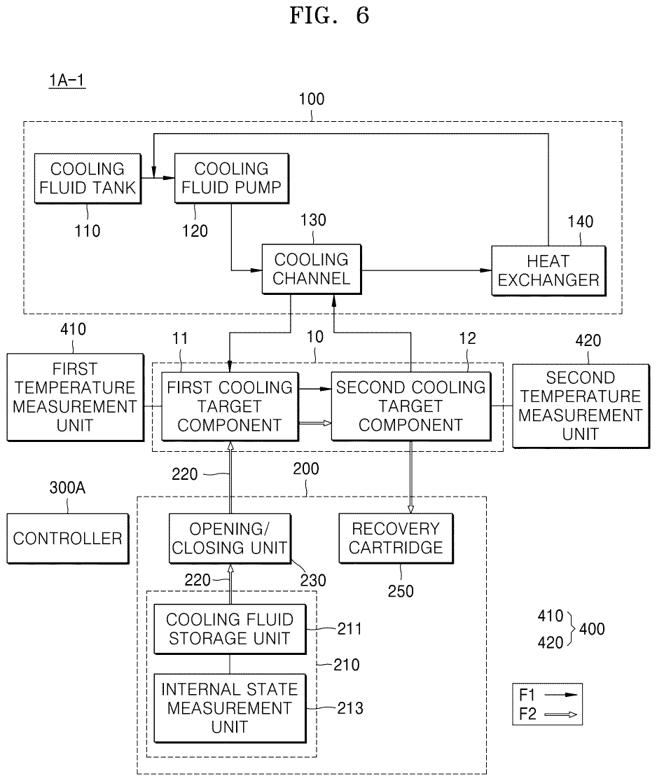

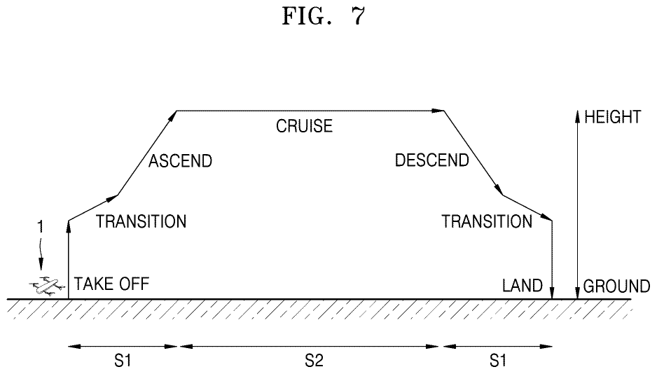

FIG. 1 illustrates an electric propulsion aircraft 1 according to embodiments. FIG. 2 is a conceptual diagram schematically illustrating a thermal management apparatus 20A for an electric propulsion aircraft according to an embodiment. FIG. 3 illustrates connections between particular components of the thermal management apparatus 20A of FIG. 2. FIG. 4 illustrates an example in which a cooling unit 100 independently cools a first cooling target component 11 and a second cooling target component 12, according to embodiments. FIG. 5 illustrates an example in which a first additional cooling unit 200 independently cools a first cooling target component 11 and a second cooling target component 12, according to an embodiment. FIG. 6 illustrates an electric propulsion aircraft 1A-1 including a recovery cartridge 250 according to an embodiment. FIG. 7 illustrates a main operation period of a first additional cooling unit 200 from take-off to landing of an electric propulsion aircraft 1A according to embodiments.

The electric propulsion aircraft 1 may include an electric vertical take-off and landing (eVTOL) aircraft that uses electric energy as a power source. In an embodiment, the electric propulsion aircraft 1 may be used as urban air mobility (UAM). In an embodiment, the electric propulsion aircraft 1 may include a drone.

Referring to FIGS. 1 and 2, the electric propulsion aircraft 1A may include an electrical component 10 and the thermal management apparatus 20A for an electric propulsion aircraft.

The electrical component 10 may include the first cooling target component 11 and the second cooling target component 12. In an embodiment, the electrical component 10 may include a motor for providing propulsion to the electric propulsion aircraft 1, an inverter for controlling the output of the motor, and a battery for supplying electric energy to the motor. The first cooling target component 11 and the second cooling target component 12 may include any one of the motor, the inverter, and the battery.

By removing heat generated during operation of the electrical component 10, the thermal management apparatus 20A may manage and control a temperature of the electrical component 10 such that the temperature is maintained within an operation temperature range. Referring to FIGS. 2 and 3, the thermal management apparatus 20A may include a cooling unit 100, a first additional cooling unit 200, a controller 300A, a first temperature measurement unit 410, and a second temperature measurement unit 420.

The cooling unit 100 may receive heat from the electrical component 10 and transmit the heat to the outside of the electric propulsion aircraft 1. The cooling unit 100 may include a cooling fluid tank 110, a cooling fluid pump 120, a cooling channel 130, and a heat exchanger 140.

The cooling fluid tank 110 may store and supply a first cooling fluid F1. The first cooling fluid F1 may function as a medium for receiving heat from the electrical component 10 and transmitting the heat to the outside. However, the first cooling fluid F1 is not particularly limited. The cooling fluid pump 120 may cause the first cooling fluid F1 to flow to be supplied to the cooling channel 130. The cooling channel 130 may cause the first cooling fluid F1 to receive heat from the electrical component 10.

Moreover, the first cooling target component 11 may have a higher cooling priority than the second cooling target component 12. For example, the first cooling target component 11 may be more vulnerable to heat than the second cooling target component 12.

Referring to FIG. 3, the cooling channel 130 may first cool the first cooling target component 11 and may then cool the second cooling target component 12. That is, the first cooling fluid F1 may first flow from the cooling channel 130 to the first cooling target component 11 to receive heat from the first cooling target component 11 and may then flow to the second cooling target component 12 to receive heat from the second cooling target component 12 and may then return back to the cooling channel 130.

In another embodiment, the cooling channel 130 may independently cool each of the first cooling target component 11 and the second cooling target component 12. Referring to FIG. 4, the cooling channel 130 may include a first cooling channel 131 and a second cooling channel 133. The first cooling channel 131 may receive heat from the first cooling target component 11. The second cooling channel 133 may receive heat from the second cooling target component 12. The cooling channel 130 may independently cool each of a plurality of electrical components 10, thereby enabling efficient and precise heat management and control.

In the heat exchanger 140, the first cooling fluid F1 having passed through the first cooling channel 131 and the second cooling channel 133 may exchange heat with the outside air. The heat exchanger 140 may inhale air from the outside of the electric propulsion aircraft 1. The heat exchanger 140 may cause the inhaled air and the first cooling fluid F1 to exchange heat with each other. The heat exchanger 140 may discharge air having received heat from the first cooling fluid F1, back to the outside of the electric propulsion aircraft 1. The first cooling fluid F1 of which the temperature has been lowered by air may be supplied from the heat exchanger 140 to the cooling fluid pump 120 to be used again to cool the electrical component 10.

The first additional cooling unit 200 may additionally cool the electrical component 10 together with the cooling unit 100. The first additional cooling unit 200 may receive heat from the electrical component 10 and transmit the heat to the outside of the electric propulsion aircraft 1A. The first additional cooling unit 200 may supply a second cooling fluid F2 to the first cooling target component 11 and the second cooling target component 12. Referring to FIGS. 3 and 4, the first additional cooling unit 200 may include a cooling cartridge 210, a second cooling fluid supply path 220, an opening/closing unit 230, and a cooling fluid discharge unit 240.

The cooling cartridge 210 may supply the second cooling fluid F2 to the electrical component 10. That is, the cooling cartridge 210 may supply the second cooling fluid F2 to the first cooling target component 11 or the second cooling target component 12. However, the second cooling fluid F2 is not particularly limited.

The cooling cartridge 210 may include a storage unit 211 and an internal state measurement unit 213. The storage unit 211 may store the second cooling fluid F2. The internal state measurement unit 213 may measure the internal temperature or pressure of the storage unit 211. The internal state measurement unit 213 may be electrically connected to the controller 300A described below. Data about the internal temperature or pressure of the storage unit 211 measured by the internal state measurement unit 213 may be transmitted to the controller 300A.

The second cooling fluid supply path 220 may be a path through which the second cooling fluid F2 is supplied from the cooling cartridge 210 to the electrical component 10. Referring to FIG. 3, the second cooling fluid supply path 220 may be arranged between the storage unit 211 and the first cooling target component 11. That is, the second cooling fluid F2 discharged from the storage unit 211 may first be supplied to the first cooling target component 11. The second cooling fluid F2 may flow to the first cooling target component 11 to receive heat from the first cooling target component 11 and may then flow to the second cooling target component 12 to receive heat from the second cooling target component 12. The second cooling fluid F2 having passed through the second cooling target component 12 may flow to the cooling fluid discharge unit 240 described below.

The opening/closing unit 230 may adjust the amount of the second cooling fluid F2 supplied to the electrical component 10. The opening/closing unit 230 may be arranged on the second cooling fluid supply path 220. The opening/closing unit 230 may be electrically connected to the controller 300A described below. The opening/closing unit 230 may receive a control signal from the controller 300A to control the flow rate of the second cooling fluid F2.

The cooling fluid discharge unit 240 may discharge the second cooling fluid F2 having passed through the electrical component 10, to the outside of the electric propulsion aircraft 1A. The second cooling fluid F2 having passed through the second cooling target component 12 may be introduced into the cooling fluid discharge unit 240. Because the cooling fluid discharge unit 240 discharges the second cooling fluid F2 to the outside, the weight of the first additional cooling unit 200 may decrease as the first additional cooling unit 200 cools the electrical component 10. This may reduce the weight of the electric propulsion aircraft 1A, thereby helping to increase the fuel efficiency of the electric propulsion aircraft 1A.

In another embodiment, the first additional cooling unit 200 may independently cool each of the first cooling target component 11 and the second cooling target component 12.

Referring to FIG. 5, the second cooling fluid supply path 220 may include a first supply path 221 and a second supply path 223. One end of the first supply path 221 may be connected to the cooling cartridge 210. The other end of the first supply path 221 may face the first cooling target component 11. The second cooling fluid F2 may flow through the first supply path 221. One end of the second supply path 223 may be connected to the cooling cartridge 210. The other end of the second supply path 223 may face the second cooling target component 12. The second cooling fluid F2 may flow through the second supply path 223. Each of the second cooling fluid F2 having passed through the first cooling target component 11 and the second cooling fluid F2 having passed through the second cooling target component 12 may flow to the cooling fluid discharge unit 240 described below.

Moreover, referring to FIG. 5, the opening/closing unit 230 may include a first opening/closing unit 231 and a second opening/closing unit 233. The first opening/closing unit 231 may be arranged on the first supply path 221. The second opening/closing unit 233 may be arranged on the second supply path 223. Each of the first opening/closing unit 231 and the second opening/closing unit 233 may be electrically connected to the controller 300A described below. The first opening/closing unit 231 and the second opening/closing unit 233 may receive a control signal from the controller 300A to control the flow rate of the second cooling fluid F2.

Referring to FIG. 5, the second cooling fluid F2 having passed through each of the first cooling target component 11 and the second cooling target component 12 may be individually introduced into the cooling fluid discharge unit 240.

The first additional cooling unit 200 may independently cool each of a plurality of electrical components 10, thereby enabling efficient and precise thermal management and control on the electrical component 10.

Referring to FIG. 6, in another embodiment, a first additional cooling unit 200A may include a cooling cartridge 210, a second cooling fluid supply path 220, an opening/closing unit 230, and a recovery cartridge 250. The cooling cartridge 210, the second cooling fluid supply path 220, and the opening/closing unit 230 may be the same as or similar to those described above, and thus, redundant descriptions thereof will be omitted for conciseness.

The second cooling fluid F2 having passed through the electrical component 10 may be introduced and stored into the recovery cartridge 250. The second cooling fluid F2 having passed through the first cooling target component 11 or the second cooling target component 12 may be introduced and stored into the recovery cartridge 250. That is, the second cooling fluid F2 having completed cooling the electrical component 10 may be recovered into the recovery cartridge 250 without being discharged to the outside of the electric propulsion aircraft 1A-1.

The recovery cartridge 250 may be detachable. The recovery cartridge 250 having stored the second cooling fluid F2 may be replaced with a new recovery cartridge 250 on the ground when the electric propulsion aircraft 1A-1 lands on the ground. The second cooling fluid F2 stored in the recovery cartridge 250 may be recooled and used in the cooling cartridge 210.

Accordingly, the environmental pollution caused by discharging the second cooling fluid F2 into the air may be prevented. Also, reusing the second cooling fluid F2 may result in resource conservation and cost reduction.

The controller 300A may control the operation of the thermal management apparatus 20A. The controller 300A may control the flow of the second cooling fluid F2 by operating the first opening/closing unit 231 and the second opening/closing unit 233. The controller 300A may determine whether to operate the first additional cooling unit 200, depending on the flight situation of the electric propulsion aircraft 1A.

Referring to FIG. 7, the flight situation of the electric propulsion aircraft 1 may include a first situation S1 and a second situation S2. The first situation S1 may include a situation in which the electric propulsion aircraft 1 takes off or lands and a situation in which the electric propulsion aircraft 1 ascends or descends in the air. The first situation S1 may include a transition situation in which the electric propulsion aircraft 1 switches from take-off mode to cruise mode or from cruise mode to landing mode. Moreover, the second situation S2 may include a situation in which the electric propulsion aircraft 1 cruises. The power required for the electric propulsion aircraft 1 in the first situation S1 may be greater than the power required for the electric propulsion aircraft 1 in the second situation S2.

In the first situation S1, the controller 300A may cool the electrical component 10 by additionally operating the first additional cooling unit 200 in addition to the cooling unit 100. That is, the controller 300A may control the operation of the thermal management apparatus 20A such that the first cooling fluid F1 and the second cooling fluid F2 may cool the first cooling target component 11 and the second cooling target component 12 together in the first situation S1. Also, the controller 300A may control the operation of the thermal management apparatus 20A such that only the first cooling fluid F1 may cool the first cooling target component 11 and the second cooling target component 12 in the second situation S2.

In other words, the cooling unit 100 may cool the electrical component 10 in all situations of the electric propulsion aircraft 1A, and the first additional cooling unit 200 may additionally cool the electrical component 10 in the first situation S1. Accordingly, by designing and producing each component of the cooling unit 100 for the second situation S2 requiring less power than the first situation S1, the weight and volume of the cooling unit 100 may be reduced compared to those for the first situation S1. This may reduce the weight and volume of the electric propulsion aircraft 1A, thereby improving the performance of the electric propulsion aircraft 1A.

The first temperature measurement unit 410 may measure the temperature of the first cooling target component 11. The second temperature measurement unit 420 may measure the temperature of the second cooling target component 12. The first temperature measurement unit 410 and the second temperature measurement unit 420 may be electrically connected to the controller 300A. The first temperature measurement unit 410 and the second temperature measurement unit 420 may transmit measured temperature values t1 and t2 to the controller 300A.

The controller 300A may control the first opening/closing unit 231 based on the temperature value t1 of the first cooling target component, measured by the first temperature measurement unit 410. The controller 300A may open the first opening/closing unit 231 when the temperature value t1 of the first cooling target component is higher than or equal to a first set temperature T1.

The first set temperature T1 may include a limit value of the operation temperature or suitable use temperature of the first cooling target component 11. When the temperature of the first cooling target component 11 is higher than or equal to the first set temperature T1, cooling by the first cooling fluid F1 of the cooling unit 100 alone may be insufficient to cool the first cooling target component 11. Thus, the controller 300A may additionally cool the first cooling target component 11 by opening the first opening/closing unit 231 to allow the second cooling fluid F2 to flow to the first cooling target component 11.

The controller 300A may control the second opening/closing unit 233 based on the temperature value t2 of the second cooling target component, measured by the second temperature measurement unit 420. The controller 300A may open the second opening/closing unit 233 when the temperature value t2 of the second cooling target component is higher than or equal to a second set temperature T2.

The second set temperature T2 may include a limit value of the operation temperature or suitable use temperature of the second cooling target component 12. When the temperature of the second cooling target component 12 is higher than or equal to the second set temperature T2, cooling by the first cooling fluid F1 of the cooling unit 100 alone may be insufficient to cool the second cooling target component 12. Thus, the controller 300A may additionally cool the second cooling target component 12 by opening the second opening/closing unit 233 to allow the second cooling fluid F2 to flow to the second cooling target component 12.

The controller 300A may independently control the first opening/closing unit 231 and the second opening/closing unit 233 based on the temperature value t1 of the first cooling target component 11 or the temperature value t2 of the second cooling target component 12, thereby enabling more efficient and precise thermal management.

The controller 300A may detect the remaining amount of the second cooling fluid F2 in the storage unit 211 based on the internal temperature or pressure of the storage unit 211, measured by the internal state measurement unit 213. The controller 300A may display the detected remaining amount of the second cooling fluid F2 on a separate display unit (not illustrated). Accordingly, cooling information may be transmitted to the user operating the electric propulsion aircraft 1A, thereby assisting in the operation of the electric propulsion aircraft 1A. Moreover, the controller 300A may control the first opening/closing unit 231 and the second opening/closing unit 233 based on the remaining amount of the second cooling fluid F2.

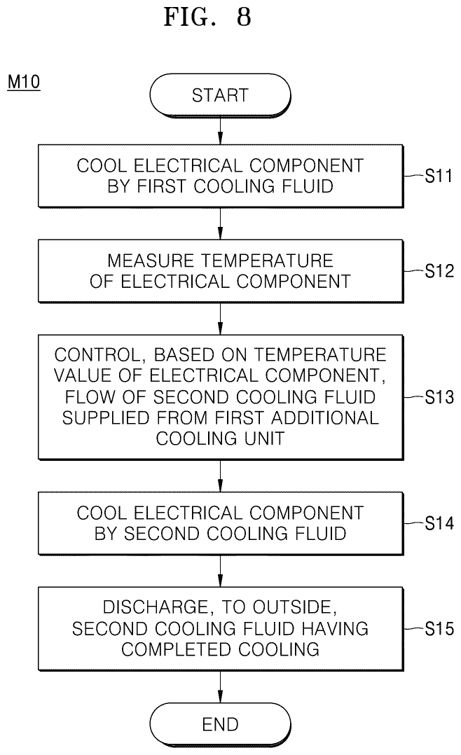

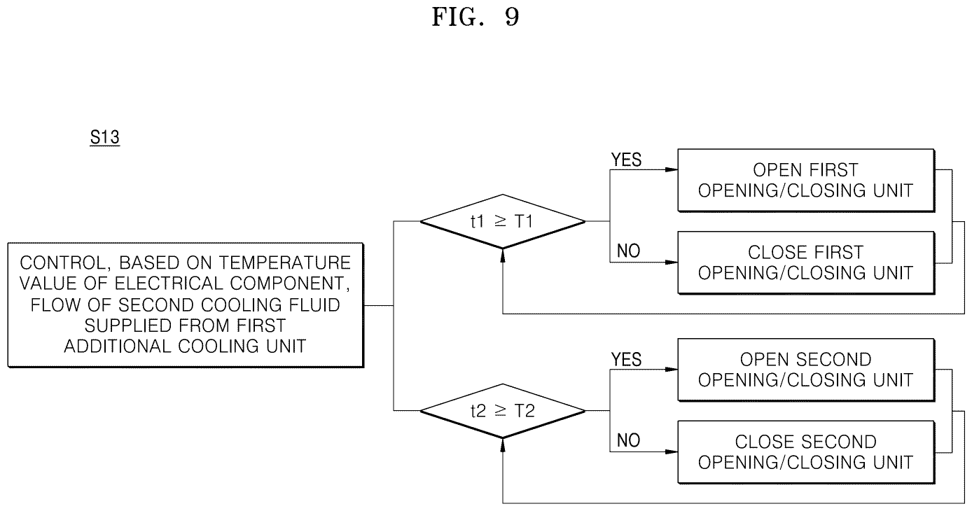

FIG. 8 is a flowchart illustrating a thermal management method M10 for an electric propulsion aircraft according to another embodiment. FIG. 9 particularly illustrates operation S13 of controlling flow of a second cooling fluid.

The thermal management method M10 may be a method of managing and controlling the temperature of the electrical component 10 to be maintained within an operation temperature range, by using the thermal management apparatus 20A to remove heat generated during operation of the electrical component 10.

Referring to FIG. 8, the thermal management method M10 may include operation S11 of cooling the first cooling target component 11 and the second cooling target component 12 by using the first cooling fluid F1, operation S12 of measuring the temperature of the first cooling target component 11 and the temperature of the second cooling target component 12, operation S13 of the controller 300A controlling the flow of the second cooling fluid F2 supplied from the first additional cooling unit 200, based on the temperature value t1 of the first cooling target component and the temperature value t2 of the second cooling target component, operation S14 of the second cooling fluid F2 cooling the first cooling target component 11 and the second cooling target component 12, and operation S15 of discharging the second cooling fluid F2 having completed cooling, to the outside of the electric propulsion aircraft.

Operation S11 of cooling by using the first cooling fluid F1 may be performed in all situations in which the electric propulsion aircraft 1A is flying. Operation S12 of measuring the temperature of the electrical component 10 may be performed from when the electric propulsion aircraft 1A starts operating. In operation S12, the controller 300A may receive the temperature value t1 of the first cooling target component and the temperature value t2 of the second cooling target component from the first temperature measurement unit 410 and the second temperature measurement unit 420, respectively.

Referring to FIG. 9, operation S13 of controlling the flow of the second cooling fluid F2 may include an operation of opening the first opening/closing unit 231 arranged on the first supply path 221 when the temperature value t1 of the first cooling target component is higher than or equal to the first set temperature T1, and an operation of opening the second opening/closing unit 233 arranged on the second supply path 223 when the temperature value t2 of the second cooling target component is higher than or equal to the second set temperature T2.

Referring to FIG. 5, one end of the first supply path 221 may be connected to the cooling cartridge 210. The other end of the first supply path 221 may face the first cooling target component 11. The second cooling fluid F2 may flow through the first supply path 221. One end of the second supply path 223 may be connected to the cooling cartridge 210. The other end of the second supply path 223 may face the second cooling target component 12. The second cooling fluid F2 may flow through the second supply path 223.

The controller 300A may independently control the first opening/closing unit 231 and the second opening/closing unit 233 based on the temperature value t1 of the first cooling target component 11 or the temperature value t2 of the second cooling target component 12, thereby enabling more efficient and precise thermal management.

In an embodiment, operation S14 of cooling by using the second cooling fluid F2 may be mainly performed in the first situation S1 described above. In another embodiment, operation S14 may be performed when the temperature value t1 of the first cooling target component is greater than or equal to the first set temperature T1 or when the temperature value t2 of the second cooling target component is greater than or equal to the second set temperature T2.

In operation S15 of discharging the second cooling fluid F2, the second cooling fluid F2 having completed cooling may be discharged to the outside of the electric propulsion aircraft 1A. Accordingly, the weight of the first additional cooling unit 200 may decrease as the first additional cooling unit 200 cools the electrical component 10. This may reduce the weight of the electric propulsion aircraft 1A, thereby helping to increase the fuel efficiency of the electric propulsion aircraft 1A.

The thermal management method M10 may cool the electrical component 10 by the first cooling fluid F1 of the cooling unit 100 and the second cooling fluid F2 of the first additional cooling unit 200 in the first situation S1 requiring more power and may cool the electrical component 10 only by the first cooling fluid F1 of the cooling unit 100 in the second situation S2 requiring less power. Accordingly, by designing and producing each component of the cooling unit 100 for the second situation S2 requiring less power than the first situation S1, the weight and volume of the cooling unit 100 may be reduced compared to those for the first situation S1. This may reduce the weight and volume of the electric propulsion aircraft 1A, thereby improving the performance of the electric propulsion aircraft 1A.

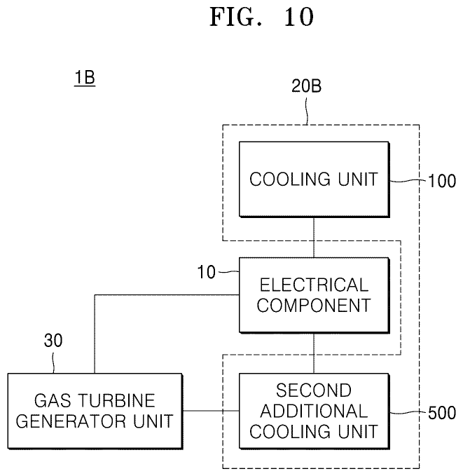

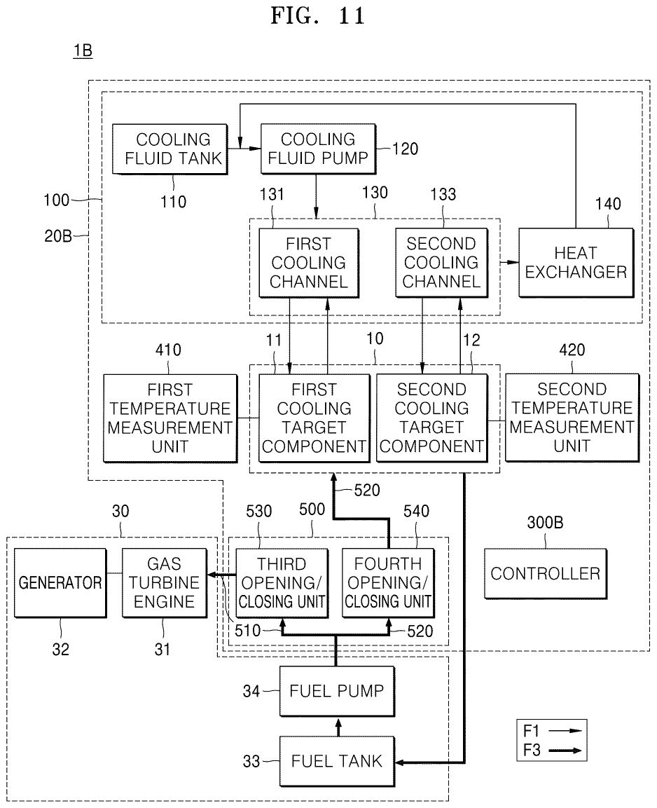

FIG. 10 is a conceptual diagram schematically illustrating a thermal management apparatus 20B for an electric propulsion aircraft according to another embodiment. FIG. 11 illustrates connections between particular components of the thermal management apparatus 20B of FIG. 10.

An electric propulsion aircraft 1B may use not only the electric energy stored in a battery but also the electric energy produced by the operation of a gas turbine, as a power source. That is, the electric propulsion aircraft 1B may include a gas turbine hybrid electric propulsion aircraft.

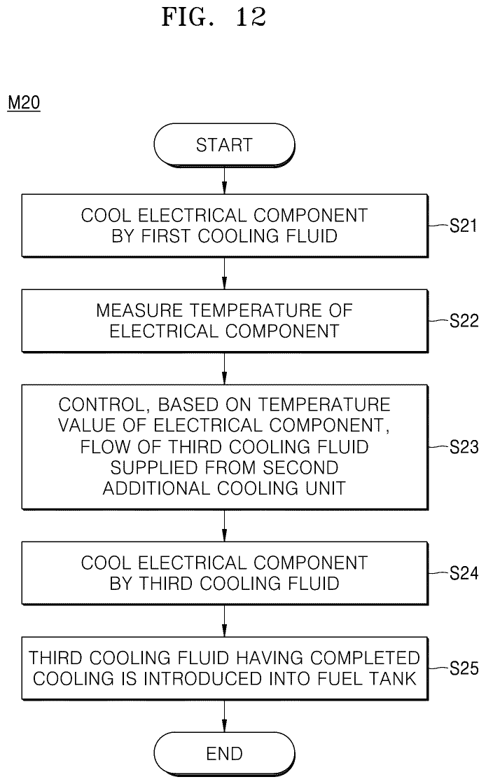

Referring to FIG. 10, the electric propulsion aircraft 1B may include an electrical component 10, a thermal management apparatus 20B for an electric propulsion aircraft, and a gas turbine generator unit 30. Among them, the electrical component 10, the cooling unit 410 of the thermal management apparatus 20B, the first temperature measurement unit 410, and the second temperature measurement unit 420 may be the same as or similar to those described in the electric propulsion aircraft 1A described above, and thus, redundant descriptions thereof will be omitted and differences therebetween will be mainly described. The same reference numerals may be used in FIGS. 11 and 12 with respect to all of the same components as those of the electric propulsion aircraft 1A illustrated in FIGS. 2 to 7.

The thermal management apparatus 20B will be described below. The gas turbine generator unit 30 may convert chemical energy of fuel into electric energy. Referring to FIG. 11, the gas turbine generator unit 30 may include a gas turbine engine 31, a generator 32, a fuel tank 33, and a fuel pump 34.

The gas turbine engine 31 may convert the chemical energy of fuel into kinetic energy by rotating a turbine with the high-temperature and high-pressure gas generated by combusting the fuel. The generator 32 may be connected to the gas turbine engine 31 to convert the kinetic energy generated by the gas turbine engine 31 into electric energy. The fuel tank 33 may store fuel and supply the fuel to the gas turbine engine 31. The fuel pump 34 may cause the fuel discharged from the fuel tank 33 to flow such that the fuel may be supplied to the gas turbine engine 31 or the electrical component 10.

By removing heat generated during operation of the electrical component 10, the thermal management apparatus 20B may manage and control a temperature of the electrical component 10 such that the temperature is maintained within an operation temperature range. Referring to FIG. 11, the thermal management apparatus 20B may include a cooling unit 100, a second additional cooling unit 500, a controller 300B, a first temperature measurement unit 410, and a second temperature measurement unit 420.

The second additional cooling unit 500 may additionally cool the electrical component 10 together with the cooling unit 100. The second additional cooling unit 500 may supply a third cooling fluid F3 to the first cooling target component 11 and the second cooling target component 12. The third cooling fluid F3 may include fuel used in the gas turbine engine 31. That is, the second additional cooling unit 500 may additionally cool the electrical component 10 by using fuel used in the gas turbine generator unit 30.

Referring to FIG. 11, the second additional cooling unit 500 may be located between the gas turbine engine 31 and the fuel tank 33. The second additional cooling unit 500 may include a power generation flow path 510, an additional cooling flow path 520, a third opening/closing unit 530, and a fourth opening/closing unit 540.

The power generation flow path 510 may be a path through which the third cooling fluid F3 is supplied from the fuel tank 33 to the gas turbine engine 31. One end of the power generation flow path 510 may be connected to the fuel tank 33. The other end of the power generation flow path 510 may be connected to the gas turbine engine 31. The third cooling fluid F3 may flow through the power generation flow path 510. The third cooling fluid F3 having flowed through the power generation flow path 510 may be supplied to the gas turbine engine 31 and used to produce power for the electric propulsion aircraft 1B.

The additional cooling flow path 520 may be a path through which the third cooling fluid F3 is supplied from the fuel tank 33 to the electrical component 10. One end of the additional cooling flow path 520 may be connected to the fuel tank 33. The other end of the additional cooling flow path 520 may face the first cooling target component 11 and the second cooling target component 12. The third cooling fluid F3 may flow through the additional cooling flow path 520. The third cooling fluid F3 having passed through the first cooling target component 11 and the second cooling target component 12 may return back to the fuel tank 33.

The third opening/closing unit 530 may control the amount of the third cooling fluid F3 supplied to the gas turbine engine 31. The third opening/closing unit 530 may be arranged on the power generation flow path 510. The third opening/closing unit 530 may be electrically connected to the controller 300B described below. The third opening/closing unit 530 may receive a control signal from the controller 300B to control the flow rate of the third cooling fluid F3.

The fourth opening/closing unit 540 may control the amount of the third cooling fluid F3 supplied to the electrical component 10. The fourth opening/closing unit 540 may be arranged on the additional cooling flow path 520. The fourth opening/closing unit 540 may be electrically connected to the controller 300B described below. The fourth opening/closing unit 540 may receive a control signal from the controller 300B to control the flow rate of the third cooling fluid F3.

The controller 300B may control the operation of the thermal management apparatus 20B. The controller 300B may control the flow of the third cooling fluid F3 by operating the third opening/closing unit 530 and the fourth opening/closing unit 540. The controller 300B may determine whether to operate the second additional cooling unit 500, depending on the flight situation of the electric propulsion aircraft 1B.

That is, the controller 300B may control the operation of the thermal management apparatus 20B such that the first cooling fluid F1 and the third cooling fluid F3 may cool the first cooling target component 11 and the second cooling target component 12 together in a first situation S1. That is, in the first situation S1, the controller 300B may close the third opening/closing unit 530 and open the fourth opening/closing unit 540.

The first situation S1 described above may be a situation in which the electric propulsion aircraft 1B is mainly close to the ground. Because the gas turbine engine 31 generates excessive noise during operation, the electric propulsion aircraft 1B may use only the electric energy stored in the battery, as a power source in the first situation S1 in which the electric propulsion aircraft 1B is mainly close to the ground.

That is, in the first situation S1, the controller 300B may stop the operation of the gas turbine engine 31 by closing the third opening/closing unit 530 to prevent the third cooling fluid F3, that is, fuel, from being supplied to the gas turbine engine 31. Simultaneously, in the first situation S1, the controller 300B may cool the electrical component 10 by the third cooling fluid F3 by opening the fourth opening/closing unit 540 to supply the third cooling fluid F3 to the electrical component 10.

Moreover, the controller 300B may open the third opening/closing unit 530 in a second situation S2. The second situation S2 described above may be a situation in which the electric propulsion aircraft 1B is located in the sky above from the ground. That is, because noise is not a problem in the second situation S2, the electric propulsion aircraft 1B may use the electric energy produced by the gas turbine generator unit 30, as a power source in the second situation S2 together with the electric energy stored in the battery.

That is, in the second situation S2, the controller 300B may supply the third cooling fluid F3, that is, fuel, to the gas turbine engine 31 by opening the third opening/closing unit 530, and the gas turbine generator unit 30 may produce electric energy.

The controller 300B may control the third opening/closing unit 530 and the fourth opening/closing unit 540 based on the temperature value t1 of the first cooling target component and the temperature value t2 of the second cooling target component. The controller 300B may be electrically connected to the first temperature measurement unit 410 and the second temperature measurement unit 420. The controller 300B may receive the measured temperature values t1 and t2 from the first temperature measurement unit 410 and the second temperature measurement unit 420.

The controller 300B may close the third opening/closing unit 530 and open the fourth opening/closing unit 540 when the temperature value t1 of the first cooling target component is higher than or equal to the first set temperature T1 described above or when the temperature value t2 of the second cooling target component is higher than or equal to the second set temperature T2 described above.

When the temperature of the electrical component 10 is higher than or equal to a set temperature, cooling by the first cooling fluid F1 of the cooling unit 100 alone may be insufficient to cool the electrical component 10. Thus, the controller 300B may additionally cool the electrical component 10 by opening the fourth opening/closing unit 540 to allow the third cooling fluid F3 to flow to the electrical component 10.

Moreover, when the temperature of the electrical component 10 is higher than or equal to the set temperature, it may be a situation in which more power is required for the electric propulsion aircraft 1B. This situation may include the first situation S1 described above, which may be a situation in which the electric propulsion aircraft 1B is mainly close to the ground. Thus, in this case, the controller 300B may close the third opening/closing unit 530 such that the third cooling fluid F3 is used only to cool the electrical component 10. Accordingly, the electrical component 10 may be rapidly cooled.

The controller 300B may open the third opening/closing unit 530 after a certain time from when the electric propulsion aircraft 1B takes off. The certain time may be determined as the average time from when the electric propulsion aircraft 1B starts operating to when the electric propulsion aircraft 1B switches from take-off mode to cruise mode. That is, the flight situation of the electric propulsion aircraft 1B after a certain time from when the electric propulsion aircraft 1B takes off may include the second situation S2 described above.

In the second situation S2, because the electric propulsion aircraft 1B is not close to the ground, noise may not be a problem. Thus, from this time, the electric propulsion aircraft 1B may use the electric energy produced by the gas turbine generator unit 30, as a power source together with the electric energy stored in the battery.

That is, the controller 300B may supply the third cooling fluid F3, that is, fuel, to the gas turbine engine 31 by opening the third opening/closing unit 530 after a certain time from when the electric propulsion aircraft 1B takes off, and the gas turbine generator unit 30 may produce electric energy.

In another embodiment, regardless of the flight mode or the proximity to the ground, the electric propulsion aircraft 1B may simultaneously use the electric energy produced by the gas turbine generator unit 30, as a power source together with the electric energy stored in the battery. In this case, the controller 300B may control only the fourth opening/closing unit 540 based on the temperature value t1 of the first cooling target component and the temperature value t2 of the second cooling target component. Also, in this case, the controller 300B may control the opening degree of the third opening/closing unit 530 when excessive power is required compared to the cruise mode, when the remaining amount of the electric energy stored in the battery is less than a certain value, or according to a user input.

The thermal management apparatus 20B may cool the electrical component 10 by the first cooling fluid F1 of the cooling unit 100 and the third cooling fluid F3 of the second additional cooling unit 500 in the first situation S1 requiring more power and may cool the electrical component 10 only by the first cooling fluid F1 of the cooling unit 100 in the second situation S2 requiring less power. Accordingly, by designing and producing each component of the cooling unit 100 for the second situation S2 requiring less power than the first situation S1, the weight and volume of the cooling unit 100 may be reduced compared to those for the first situation S1. This may reduce the weight and volume of the electric propulsion aircraft 1B, thereby improving the performance of the electric propulsion aircraft 1B.

Because the thermal management apparatus 20B uses, for cooling, the third cooling fluid F3 mounted on the electric propulsion aircraft 1B, that is, the fuel used in the gas turbine engine 31, it may be economical in that the cooling capacity may be increased without additional complex equipment, except for allowing the fuel to flow to the electrical component 10 by diverging from the movement path of the fuel.

The performance of the gas turbine engine 31 may be improved as the temperature of the fuel supplied to the gas turbine engine 31 increases. The thermal management apparatus 20B may use the third cooling fluid F3, that is, fuel, to cool the electrical components 10. The temperature of the fuel may increase by receiving heat from the electrical components 10. Thus, the thermal management apparatus 20B may supply, to the gas turbine engine 31, the third cooling fluid F3, the temperature of which has increased by cooling the electrical component 10, thereby improving the performance of the gas turbine engine 31.

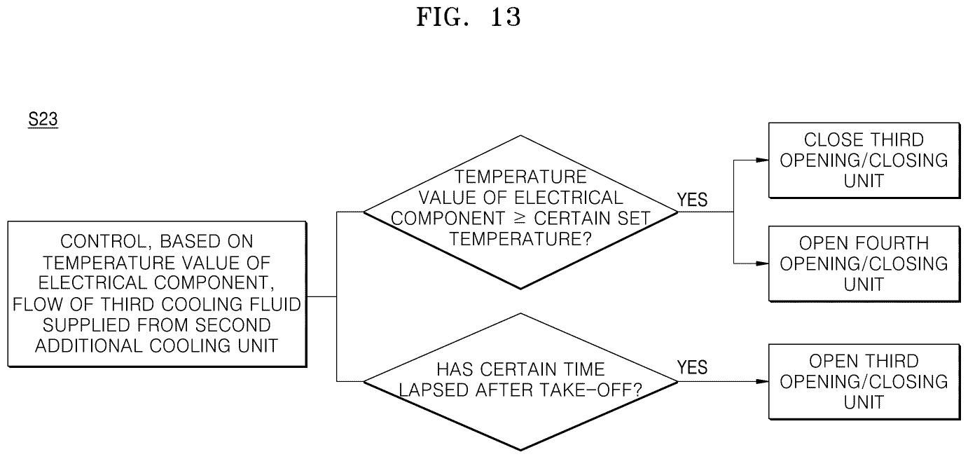

FIG. 12 is a flowchart illustrating a thermal management method M20 for an electric propulsion aircraft according to another embodiment. FIG. 13 particularly illustrates operation S23 of controlling flow of a third cooling fluid F3.

The thermal management method M20 may be a method of managing and controlling the temperature of the electrical component 10 to be maintained within an operation temperature range, by using the thermal management apparatus 20B to remove heat generated during operation of the electrical component 10.

Referring to FIG. 12, the thermal management method M20 may include operation S21 of cooling the first cooling target component 11 and the second cooling target component 12 by using the first cooling fluid F1, operation S22 of measuring the temperature of the first cooling target component 11 and the second cooling target component 12, operation S23 of controlling the flow of the third cooling fluid F3, supplied from the second additional cooling unit 500, by using the controller 300B, based on the temperature value of the first cooling target component 11 or the second cooling target component 12, operation S24 of cooling the first cooling target component 11 and the second cooling target component 12 by using the third cooling fluid F3, and operation S25 of introducing the third cooling fluid F3 having completed cooling, into the fuel tank 33.

Operation S21 of cooling by using the first cooling fluid F1 may be performed in all situations in which the electric propulsion aircraft 1B is flying. Operation S22 of measuring the temperature of the electrical component 10 may be performed from when the electric propulsion aircraft 1B starts operating. In operation S22, the controller 300B may receive the temperature value of the first cooling target component and the temperature value of the second cooling target component from the first temperature measurement unit 410 and the second temperature measurement unit 420, respectively.

Referring to FIG. 13, operation S23 of controlling the flow of the third cooling fluid F3 may include an operation of closing the third opening/closing unit 530 arranged on the power generation flow path 510 and opening the fourth opening/closing unit 540 arranged on the additional cooling flow path 520, when the temperature value of the first cooling target component 11 or the second cooling target component 12 is higher than or equal to a certain set temperature.

Referring to FIG. 11, one end of the power generation flow path 510 may be connected to the fuel tank 33. The other end of the power generation flow path 510 may be connected to the gas turbine engine 31. The third cooling fluid F3 may flow through the power generation flow path 510. One end of the additional cooling flow path 520 may be connected to the fuel tank 33. The other end of the additional cooling flow path 520 may face the first cooling target component 11 and the second cooling target component 12. The third cooling fluid F3 may flow through the additional cooling flow path 520.

When the temperature of the electrical component 10 is higher than or equal to the set temperature, it may be a situation in which more power is required for the electric propulsion aircraft 1B. This situation may include the first situation S1 described above.

Referring to FIG. 13, operation S23 of controlling the flow of the third cooling fluid F3 may further include an operation of opening the third opening/closing unit 530 after a certain time from when the electric propulsion aircraft 1A takes off.

The flight situation of the electric propulsion aircraft 1B after a certain time from when the electric propulsion aircraft 1B takes off may include the second situation S2 described above.

That is, the thermal management apparatus 20B may cool the electrical component 10 by the first cooling fluid F1 of the cooling unit 100 and the third cooling fluid F3 of the second additional cooling unit 500 in the first situation S1 requiring more power and may cool the electrical component 10 only by the first cooling fluid F1 of the cooling unit 100 in the second situation S2 requiring less power. Accordingly, by designing and producing each component of the cooling unit 100 for the second situation S2 requiring less power than the first situation S1, the weight and volume of the cooling unit 100 may be reduced compared to those for the first situation S1. This may reduce the weight and volume of the electric propulsion aircraft 1B, thereby improving the performance of the electric propulsion aircraft 1B.

Operation S24 of cooling by using the third cooling fluid F3 may be performed when the temperature value of the first cooling target component 11 or the second cooling target component 12 is higher than or equal to a certain set temperature. Operation S24 may be mainly performed in the first situation S1 described above.

In operation S25 of introducing the third cooling fluid F3 into the fuel tank 33, the third cooling fluid F3 having completed cooling may be introduced into the fuel tank 33. The fuel stored in the fuel tank 33 may be supplied to the gas turbine engine 31. That is, the third cooling fluid F3, the temperature of which has increased by cooling the electrical component 10, may be supplied to the gas turbine engine 31. The performance of the gas turbine engine 31 may be improved as the temperature of the fuel supplied to the gas turbine engine 31 increases. Thus, the performance of the gas turbine engine 31 may be improved by operation S25.

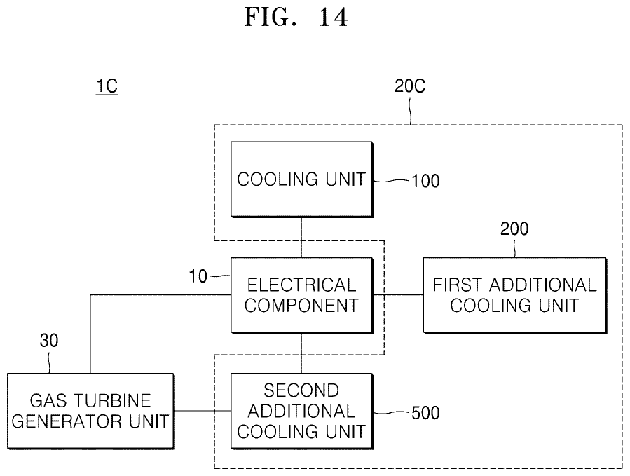

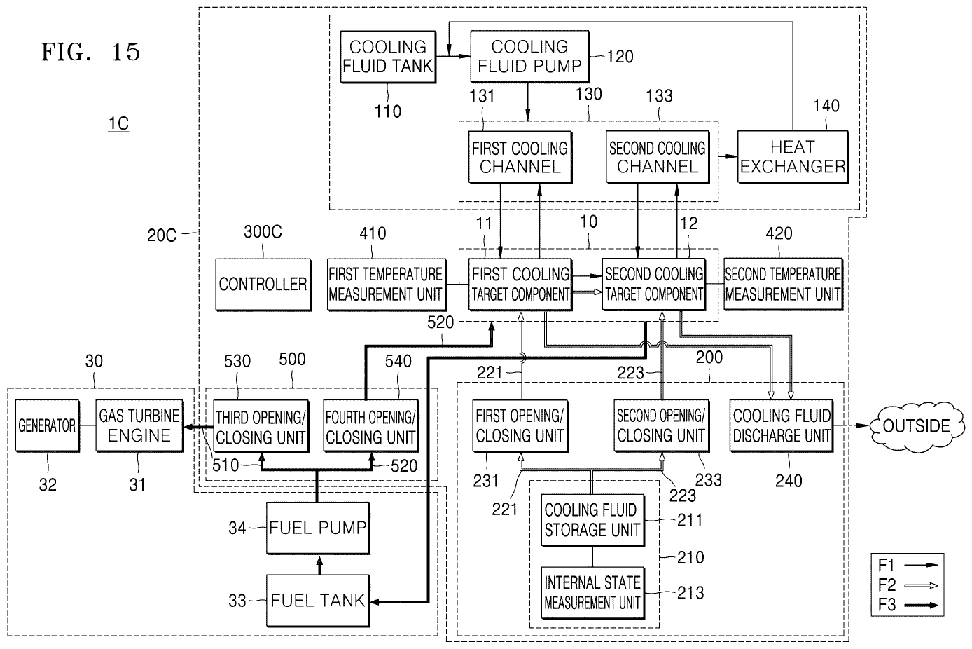

FIG. 14 is a conceptual diagram schematically illustrating a thermal management apparatus 20C for an electric propulsion aircraft according to another embodiment. FIG. 15 illustrates connections between particular components of the thermal management apparatus 20C of FIG. 14.

An electric propulsion aircraft 1C may use not only the electric energy stored in a battery but also the electric energy produced by the operation of a gas turbine, as a power source. That is, the electric propulsion aircraft 1C may include a gas turbine hybrid electric propulsion aircraft.

Referring to FIG. 14, the electric propulsion aircraft 1C may include an electrical component 10, a thermal management apparatus 20C for an electric propulsion aircraft, and a gas turbine generator unit 30. Among them, the electrical component 10, the gas turbine generator unit 30, the cooling unit 100 of the thermal management apparatus 20C, the first additional cooling unit 200, the first temperature measurement unit 410, the second temperature measurement unit 420, and the second additional cooling unit 500 may be the same as or similar to those described in the electric propulsion aircraft 1A and the electric propulsion aircraft 1B described above, and thus, redundant descriptions thereof will be omitted and differences therebetween will be mainly described. The same reference numerals may be used in FIGS. 14 and 15 with respect to all of the same components as those of the electric propulsion aircrafts 1A and 1B illustrated in FIGS. 2 to 11.

By removing heat generated during operation of the electrical component 10, the thermal management apparatus 20C may manage and control a temperature of the electrical component 10 such that the temperature is maintained within an operation temperature range. Referring to FIGS. 14 and 15, the thermal management apparatus 20C may include a cooling unit 100, a first additional cooling unit 200, a controller 300C, a first temperature measurement unit 410, a second temperature measurement unit 420, and a second additional cooling unit 500.

The controller 300C may include all of the controllers 300A and 300B described in the electric propulsion aircrafts 1A and 1B described above.

That is, in the first situation S1 described above, the controller 300C may cool the electrical component 10 by additionally operating the first additional cooling unit 200 and the second additional cooling unit 500 in addition to the cooling unit 100. That is, the controller 300C may control the operation of the thermal management apparatus 20C such that the first cooling fluid F1, the second cooling fluid F2, and the third cooling fluid F3 may cool the first cooling target component 11 and the second cooling target component 12 together in the first situation S1.

Also, the controller 300C may control the first opening/closing unit 231, the second opening/closing unit 233, the third opening/closing unit 530, and the fourth opening/closing unit 540 based on the temperature value t1 of the first cooling target component and the temperature value t2 of the second cooling target component, measured by the first temperature measurement unit 410 and the second temperature measurement unit 420.

The thermal management apparatus 20C may cool the electrical component 10 by the first cooling fluid F1 of the cooling unit 100, the second cooling fluid F2 of the first additional cooling unit 200, and the third cooling fluid F3 of the second additional cooling unit 500 in the first situation S1 requiring more power and may cool the electrical component 10 only by the first cooling fluid F1 of the cooling unit 100 in the second situation S2 requiring less power. Accordingly, by designing and producing each component of the cooling unit 100 for the second situation S2 requiring less power than the first situation S1, the weight and volume of the cooling unit 100 may be reduced compared to those for the first situation S1. This may reduce the weight and volume of the electric propulsion aircraft 1C, thereby improving the performance of the electric propulsion aircraft 1C.

The thermal management apparatus 20C may supply, to the gas turbine engine 31, the third cooling fluid F3, the temperature of which has increased by cooling the electrical component 10, thereby improving the performance of the gas turbine engine 31.

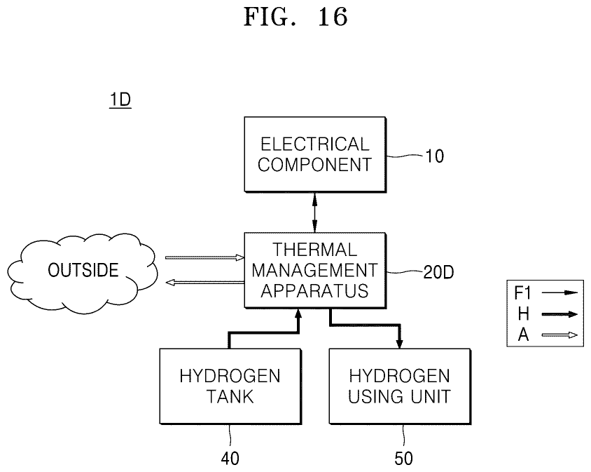

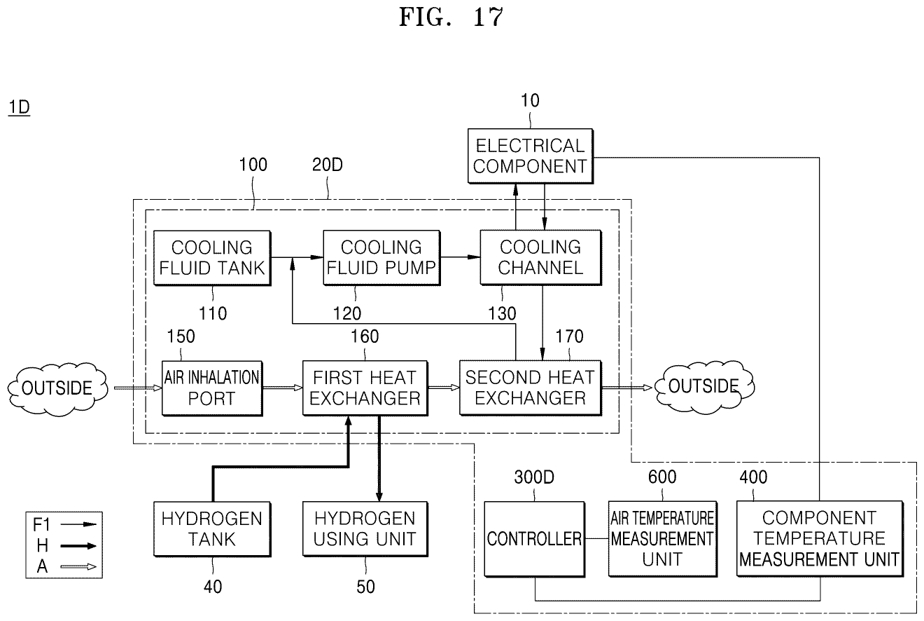

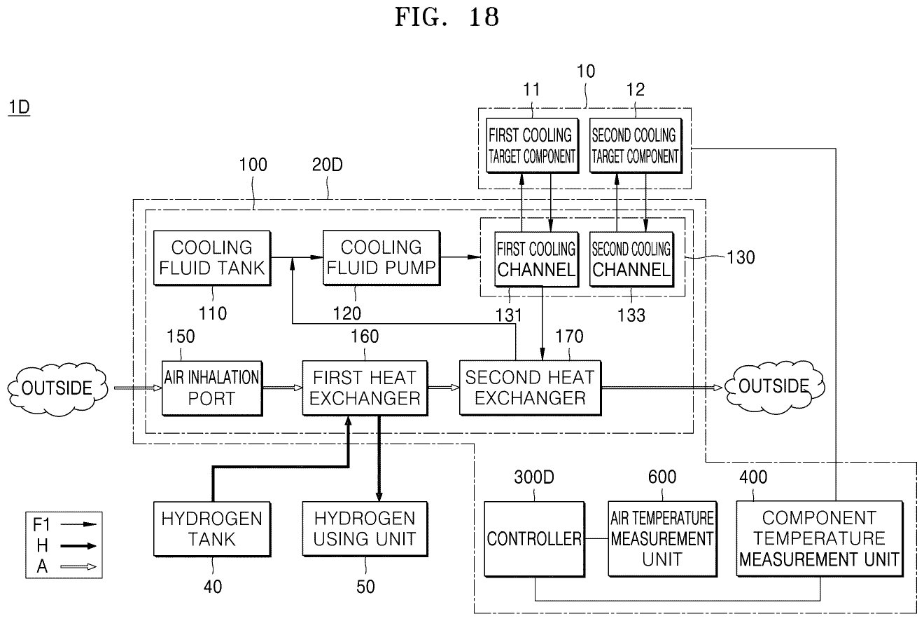

FIG. 16 is a conceptual diagram schematically illustrating a thermal management apparatus 20D for an electric propulsion aircraft according to an embodiment. FIG. 17 illustrates connections between particular components of the thermal management apparatus 20D of FIG. 16. FIG. 18 illustrates an example in which a cooling unit 100 independently cools a first cooling target component 11 and a second cooling target component 12, according to embodiments.

The electric propulsion aircraft 1 may include an eVTOL aircraft that uses hydrogen and uses electric energy as a power source. Referring to FIG. 16, an electric propulsion aircraft 1D may include an electrical component 10, a hydrogen tank 40, a hydrogen using unit 50, and a thermal management apparatus 20D for an electric propulsion aircraft.

The hydrogen tank 40 may store hydrogen H and supply the hydrogen H to the hydrogen using unit 50 described below. The hydrogen H stored in the hydrogen tank 40 may include a cryogenic liquid state. The hydrogen using unit 50 may include a device for producing electric energy by using hydrogen. In an embodiment, the hydrogen using unit 50 may include a fuel cell that uses hydrogen H as fuel and a gas turbine generator that uses hydrogen H as fuel.

By removing heat generated during operation of the electrical component 10, the thermal management apparatus 20D may manage and control a temperature of the electrical component 10 such that the temperature is maintained within an operation temperature range. Referring to FIGS. 16 and 17, the thermal management apparatus 20D may include a cooling unit 100, a controller 300D, an air temperature measurement unit 600, and a component temperature measurement unit 400.

The cooling unit 100 may receive heat from the electrical component 10 and transmit the heat to the outside of the electric propulsion aircraft 1D. The cooling unit 100 may include a cooling fluid tank 110, a cooling fluid pump 120, a cooling channel 130, an air inhalation port 150, a first heat exchanger 160, and a second heat exchanger 170.

The cooling fluid tank 110 may store and supply a first cooling fluid F1. The first cooling fluid F1 may function as a medium for receiving heat from the electrical component 10 and transmitting the heat to the outside. However, the first cooling fluid F1 is not particularly limited. The cooling fluid pump 120 may cause the first cooling fluid F1 to flow to be supplied to the cooling channel 130.

The cooling channel 130 may cause the first cooling fluid F1 to receive heat from the electrical component 10. In an embodiment, the cooling channel 130 may independently cool each of the first cooling target component 11 and the second cooling target component 12. Referring to FIG. 18, the cooling channel 130 may include a first cooling channel 131 and a second cooling channel 133. The first cooling channel 131 may receive heat from the first cooling target component 11. The second cooling channel 133 may receive heat from the second cooling target component 12. The cooling channel 130 may independently cool each of a plurality of electrical components 10, thereby enabling efficient and precise heat management and control.

The air inhalation port 150 may inhale air A outside the electric propulsion aircraft 1D into the inside thereof. The air inhalation port 150 may change the flow rate of the air A that is inhaled. The air inhalation port 150 may be electrically connected to the controller 300D described below. The air inhalation port 150 may receive a control signal from the controller 300D to change the flow rate of air A that is inhaled.

In the first heat exchanger 160, hydrogen H supplied from the hydrogen tank 40 and air A supplied from the air inhalation port 150 may exchange heat with each other. A method by which hydrogen H and air A exchange heat with each other is not particularly limited. Hydrogen H supplied from the hydrogen tank 40 may be vaporized by receiving heat from air A in a cryogenic liquid state. The air A supplied from the air inhalation port 150 may decrease in temperature by transmitting heat to hydrogen H.

The first heat exchanger 160 may supply the hydrogen H having completed heat exchange, to the hydrogen using unit 50. The first heat exchanger 160 may supply the air A having completed heat exchange, to the second heat exchanger 170.

The hydrogen using unit 50 may require hydrogen H in a gaseous state, but hydrogen H stored in the hydrogen tank 40 may be in a cryogenic liquid state. The first heat exchanger 160 may function as a vaporizer in the electric propulsion aircraft 1D that uses hydrogen. That is, because hydrogen H of a cryogenic liquid state stored in the hydrogen tank 40 is vaporized by receiving heat from the outside air A in the first heat exchanger 160, it may be supplied to the hydrogen using unit 50 in the state of being directly usable in the hydrogen using unit 50. Accordingly, because it is not necessary to arrange a separate vaporizer, the configuration of the electric propulsion aircraft 1D may be simplified and the weight thereof may be reduced to improve the performance thereof.

In the second heat exchanger 170, the first cooling fluid F1 having passed through the cooling channel 130 and the air A having completed heat exchange in the first heat exchanger 160 may exchange heat with each other. A method by which the first cooling fluid F1 and the air A exchange heat with each other is not particularly limited. The first cooling fluid F1 having increased in temperature by receiving heat from the electrical component 10 while passing through the cooling channel 130 may transmit heat to the air A and decrease in temperature again. The air A supplied from the first heat exchanger 160 may cool the first cooling fluid F1 while increasing in temperature by receiving heat from the first cooling fluid F1.

The second heat exchanger 170 may supply the first cooling fluid F1 having completed heat exchange, to the cooling fluid pump 120. The second heat exchanger 170 may discharge the air A having completed heat exchange, to the outside.

The performance of a heat exchanger may depend on the heat exchanger inlet temperature of a material cooling a target. That is, the performance of the heat exchanger may increase as the heat exchanger inlet temperature of the material cooling the target decreases. Thus, as the temperature at which the air A cooling the first cooling fluid F1 is supplied to the second heat exchanger 170 decreases, a heat exchange may occur more easily and thus the temperature of the first cooling fluid F1 may be more effectively lowered. In the thermal management apparatus 20D, because the outside air A inhaled through the air inhalation port 150 is supplied to the second heat exchanger 170 in the state of being lowered in temperature by vaporizing the hydrogen H while passing through the first heat exchanger 160, the heat exchange performance of the second heat exchanger 170 may be improved. Accordingly, the cooling performance of the cooling unit 100 may also be improved.

The controller 300D may control the operation of the thermal management apparatus 20D. The air temperature measurement unit 600 may measure the air temperature outside the electric propulsion aircraft 1D. The component temperature measurement unit 400 may measure the temperature of the electrical component 10. The air temperature measurement unit 600 and the component temperature measurement unit 400 may be electrically connected to the controller 300D. Each of the air temperature measurement unit 600 and the component temperature measurement unit 400 may transmit the measured temperature value to the controller 300D.

The controller 300D may control the flow rate of the air inhalation port 150 based on the air temperature value measured by the air temperature measurement unit 600. In an embodiment, when the measured air temperature value is higher than a preset temperature, the flow rate of the air inhalation port 150 may be reduced. On the other hand, when the measured air temperature value is lower than the preset temperature, the flow rate of the air inhalation port 150 may be increased.

The controller 300D may control the flow rate of the air inhalation port 150 based on the temperature value of the electrical component 10 measured by the component temperature measurement unit 400. In an embodiment, when the measured temperature value of the electrical component 10 is higher than a preset temperature, the flow rate of the air inhalation port 150 may be increased. On the other hand, when the measured temperature value of the electrical component 10 is lower than the preset temperature, the flow rate of the air inhalation port 150 may be reduced.

By controlling the flow rate of the air inhalation port 150 based on the measured air temperature value or the measured temperature value of the electrical component 10, by inhaling air by only the flow rate of air required for heat exchange, unnecessary power consumption by the second heat exchanger 170 may be reduced and the thermal management performance of the thermal management apparatus 20D may be optimized.

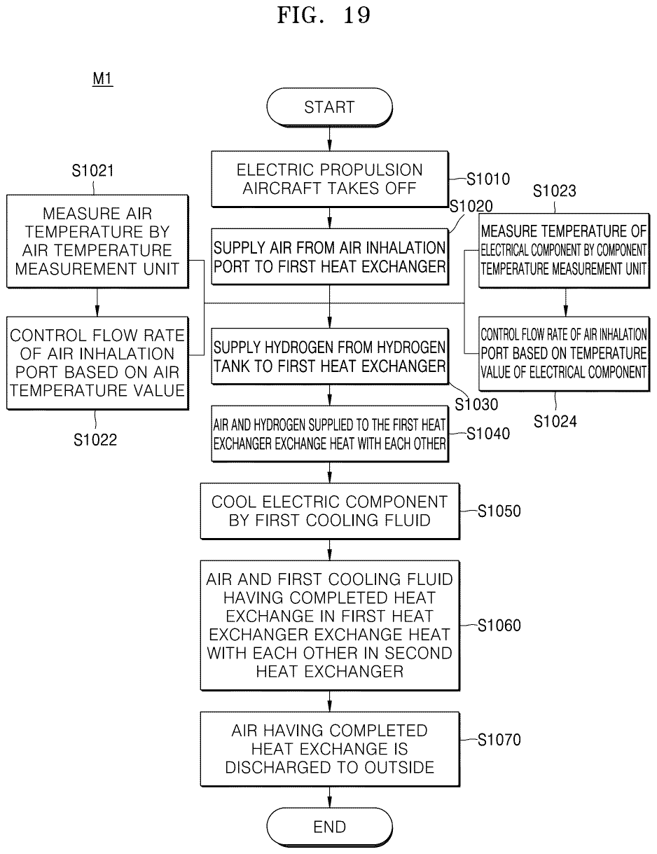

FIG. 19 is a flowchart illustrating a thermal management method M1 for an electric propulsion aircraft according to another embodiment.

The thermal management method M1 may be a method of managing and controlling the temperature of the electrical component 10 to be maintained within an operation temperature range, by using the thermal management apparatus 20 to remove heat generated during operation of the electrical component 10.

Referring to FIG. 19, the thermal management method M1 may include operation S1010 of the electric propulsion aircraft 1 taking off, operation S1020 of supplying air A from the air inhalation port 150 to the first heat exchanger 160, operation S1030 of supplying hydrogen H from the hydrogen tank 40 to the first heat exchanger 160, operation S1040 in which the hydrogen H and the air A supplied to the first heat exchanger 160 exchange heat with each other, operation S1050 of cooling the electrical component 10 by using the first cooling fluid F1, operation S1060 in which the first cooling fluid F1 and the air A having completed heat exchange in the first heat exchanger 160 are supplied to the second heat exchanger 170 to exchange heat with each other, and operation S1070 in which the air A having completed heat exchange in the second heat exchanger 170 is discharged to the outside of the electric propulsion aircraft 1.

First, the electric propulsion aircraft 1 may take off (S1010). During the take-off process of the electric propulsion aircraft 1, the electrical component 10 may operate and thermal management for the electrical components 10 may be required.

The air A may be supplied from the air inhalation port 150 to the first heat exchanger 160 (S1020). This operation S1020 may include operation S1021 of the air temperature measurement unit 600 measuring the air temperature and operation S1022 of the controller 300D controlling the flow rate of the air inhalation port 150 based on the air temperature value measured by the air temperature measurement unit 600. In an embodiment, when the measured air temperature value is higher than a preset temperature, the flow rate of the air inhalation port 150 may be reduced. On the other hand, when the measured air temperature value is lower than the preset temperature, the flow rate of the air inhalation port 150 may be increased.

This operation S1020 may include operation S1023 of the component temperature measurement unit 400 measuring the temperature of the electrical component and operation S1024 of the controller 300D controlling the flow rate of the air inhalation port 150 based on the temperature value of the electrical component 10 measured by the component temperature measurement unit 400. When the measured temperature value of the electrical component 10 is higher than a preset temperature, the flow rate of the air inhalation port 150 may be increased. On the other hand, when the measured temperature value of the electrical component 10 is lower than the preset temperature, the flow rate of the air inhalation port 150 may be reduced.

By controlling the flow rate of the air inhalation port 150 based on the measured air temperature value or the measured temperature value of the electrical component 10, by inhaling air by only the flow rate of air required for heat exchange, unnecessary power consumption by the second heat exchanger 170 may be reduced and the thermal management performance of the thermal management apparatus 20 may be optimized.

Operation S1030 of supplying the hydrogen H to the first heat exchanger 160 may be performed simultaneously with the air A supplying operation S1020. Heat exchange between the air A and the hydrogen H may be performed (S1040) after the air A supplying operation S1020 and the hydrogen H supplying operation S1030.

Moreover, the cooling operation S1050 of the first cooling fluid F1 may be performed in all situations in which the electric propulsion aircraft 1 is flying. The air A having gone through operation S1040 and the first cooling fluid F1 having gone through operation S1050 may exchange heat with each other in the second heat exchanger 170 (S1060). The air A having completed heat exchange with the first cooling fluid F1 may be discharged to the outside of the electric propulsion aircraft 1 (S1070). Accordingly, the heat generated in the electrical component 10 may be discharged to the air outside the electric propulsion aircraft 1.

In the thermal management method M1, hydrogen H in a cryogenic liquid state may be vaporized in the heat exchange operation S1040 in the first heat exchanger 160. Accordingly, because a separate vaporizer is not required, the configuration of the electric propulsion aircraft 1 may be simplified and the weight thereof may be reduced to improve the performance thereof. Also, because the air A is supplied to the second heat exchanger 170 in the state of being lowered in temperature by vaporizing the hydrogen H while passing through the first heat exchanger 160 in operation S1040, the heat exchange performance of the second heat exchanger 170 may be improved. Accordingly, the cooling performance of the cooling unit 100 may also be improved.

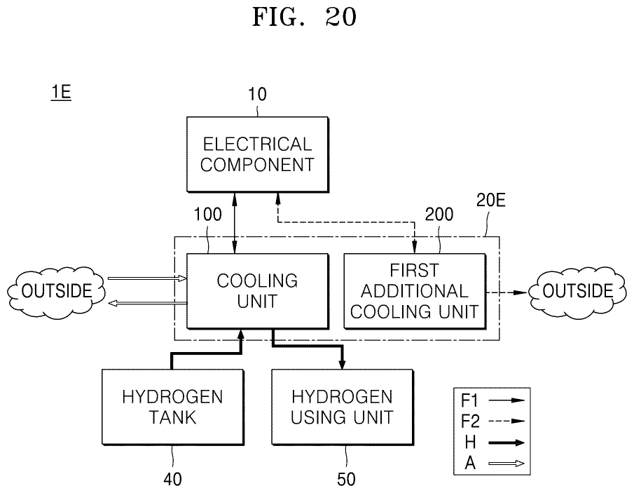

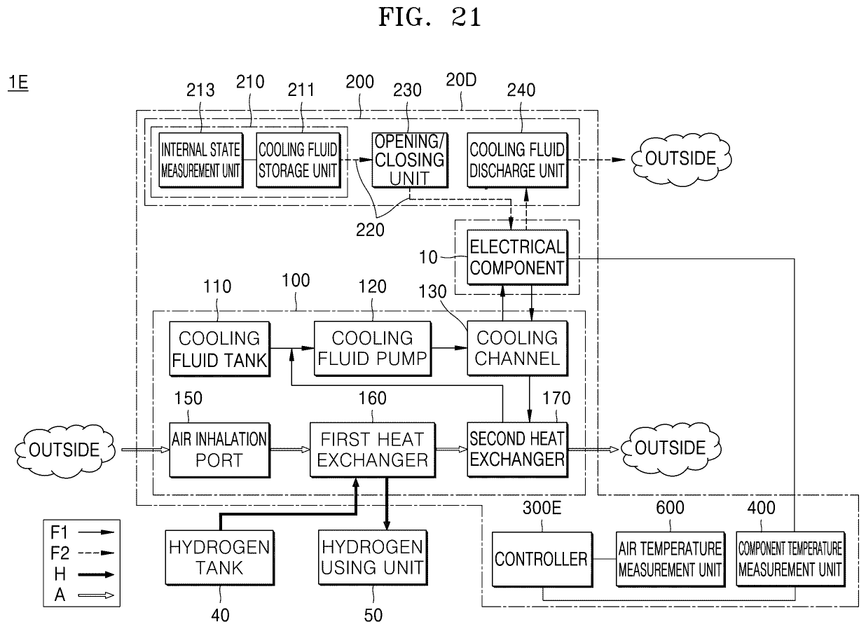

FIG. 20 is a conceptual diagram schematically illustrating a thermal management apparatus 20E for an electric propulsion aircraft according to another embodiment. FIG. 21 illustrates connections between particular components of the thermal management apparatus 20E of FIG. 20.

Referring to FIG. 20, an electric propulsion aircraft 1E may include an electrical component 10, a hydrogen tank 40, a hydrogen using unit 50, and a thermal management apparatus 20E for an electric propulsion aircraft. Among them, the electrical component 10, the hydrogen tank 40, the hydrogen using unit 50, the cooling unit 600 of the thermal management apparatus 20E, the air temperature measurement unit 600, and the component temperature measurement unit 400 may be the same as or similar to those described in the electric propulsion aircraft 1D described above, and thus, redundant descriptions thereof will be omitted and differences therebetween will be mainly described. The same reference numerals may be used in FIGS. 20 and 21 with respect to all of the same components as those of the electric propulsion aircraft 1D illustrated in FIGS. 16 to 18.

By removing heat generated during operation of the electrical component 10, the thermal management apparatus 20E may manage and control a temperature of the electrical component 10 such that the temperature is maintained within an operation temperature range. Referring to FIG. 21, the thermal management apparatus 20E may include a cooling unit 100, a controller 300E, an air temperature measurement unit 600, a component temperature measurement unit 400, and a first additional cooling unit 200.

The first additional cooling unit 200 may cool the electrical component 10 by using the second cooling fluid F2. The first additional cooling unit 200 may receive heat from the electrical component 10 and transmit the heat to the outside of the electric propulsion aircraft 1E. The first additional cooling unit 200 may be the same as or similar to that described in FIGS. 3 and 4, and thus, redundant descriptions thereof will be omitted for conciseness.

The controller 300E may control the operation of the thermal management apparatus 20E. The controller 300E may control the flow of the second cooling fluid F2 by operating the opening/closing unit 230. The controller 300E may determine whether to operate the first additional cooling unit 200, depending on the flight situation of the electric propulsion aircraft 1E.

In the first situation S1, the controller 300E may cool the electrical component 10 by additionally operating the first additional cooling unit 200 in addition to the cooling unit 100. That is, the controller 300E may control the operation of the thermal management apparatus 20E such that the first cooling fluid F1 and the second cooling fluid F2 may cool the electrical component 10 together in the first situation S1. Also, the controller 300E may control the operation of the thermal management apparatus 20E such that only the first cooling fluid F1 may cool the electrical component 10 in the second situation S2.

In other words, the cooling unit 100 may cool the electrical component 10 in all situations of the electric propulsion aircraft 1E, and the first additional cooling unit 200 may additionally cool the electrical component 10 in the first situation S1. Accordingly, by designing and producing each component of the cooling unit 100 for the second situation S2 requiring less power than the first situation S1, the weight and volume of the cooling unit 100 may be reduced compared to those for the first situation S1. This may reduce the weight and volume of the electric propulsion aircraft 1E, thereby improving the performance of the electric propulsion aircraft 1E.

The controller 300E may control the opening/closing unit 230 based on the temperature value of the electrical component 10 measured by the component temperature measurement unit 400. The controller 300E may open the opening/closing unit 230 when the temperature value of the electrical component 10 is higher than a preset temperature.

The controller 300E may detect the remaining amount of the second cooling fluid F2 in the storage unit 211 based on the internal temperature or pressure of the storage unit 211, measured by the internal state measurement unit 213. The controller 300E may display the detected remaining amount of the second cooling fluid F2 on a separate display unit (not illustrated). Accordingly, cooling information may be transmitted to the user operating the electric propulsion aircraft 1E, thereby assisting in the operation of the electric propulsion aircraft 1E. Moreover, the controller 300E may control the opening/closing unit 230 based on the remaining amount of the second cooling fluid F2.

Moreover, the controller 300E may include the controller 300D described in the electric propulsion aircraft 1D described above. That is, the controller 300E may control the flow rate of the air inhalation port 150 based on the air temperature value measured by the air temperature measurement unit 600 or the temperature value of the electrical component 10 measured by the component temperature measurement unit 400.

In the thermal management apparatus 20E, because the first heat exchanger 160 functions as a vaporizer and thus it is not necessary to arrange a separate vaporizer, the configuration of the electric propulsion aircraft 1E may be simplified and the weight thereof may be reduced to improve the performance thereof. Also, because the outside air A is supplied to the second heat exchanger 170 in the state of being lowered in temperature by passing through the first heat exchanger 160, the heat exchange performance of the second heat exchanger 170 may be improved and the cooling performance of the cooling unit 100 may also be improved.

Also, because the weight and volume of the cooling unit 100 may be designed and produced for the second situation S2 requiring less power than the first situation S1, the weight and volume of the electric propulsion aircraft 1E may be reduced to improve the performance of the electric propulsion aircraft 1E.

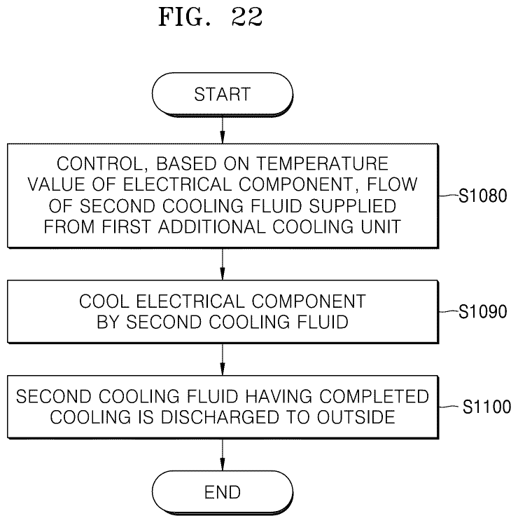

FIG. 22 is a flowchart illustrating operations that may be added to the thermal management method M1 of FIG. 19 when a thermal management apparatus 20E for an electric propulsion aircraft includes a first additional cooling unit 200.

Referring to FIG. 22, in the case of using the thermal management apparatus 20E including the first additional cooling unit 200, the thermal management method M1 may further include operation S1080 of the controller 300E controlling the flow of the second cooling fluid F2 supplied from the first additional cooling unit 200, based on the temperature value of the electrical component 10, operation S1090 of the second cooling fluid F2 cooling the electrical component 10, and operation S1100 of discharging the second cooling fluid F2 having completed cooling, to the outside of the electric propulsion aircraft 1E.

In operation S1080 of controlling the flow of the second cooling fluid F2, the opening/closing unit 230 may be opened when the temperature value of the electrical component 10 is higher than a preset temperature. The cooling operation S1090 of the second cooling fluid F2 may be mainly performed in the first situation S1 described above. In another embodiment, operation S1090 may be performed when the temperature value of the electrical component 10 is higher than the preset temperature. In operation S1100 of discharging the second cooling fluid F2, the second cooling fluid F2 having completed cooling may be discharged to the outside of the electric propulsion aircraft 1E. Accordingly, the weight of the first additional cooling unit 200 may decrease as the first additional cooling unit 200 cools the electrical component 10. This may reduce the weight of the electric propulsion aircraft 1E, thereby helping to increase the fuel efficiency of the electric propulsion aircraft 1E.

Referring to FIGS. 19 and 22, in the thermal management method M1, the operations S1080 to S1100 may be performed simultaneously with the operations S1020 to S1070 described in FIG. 19, regardless of the time sequence.

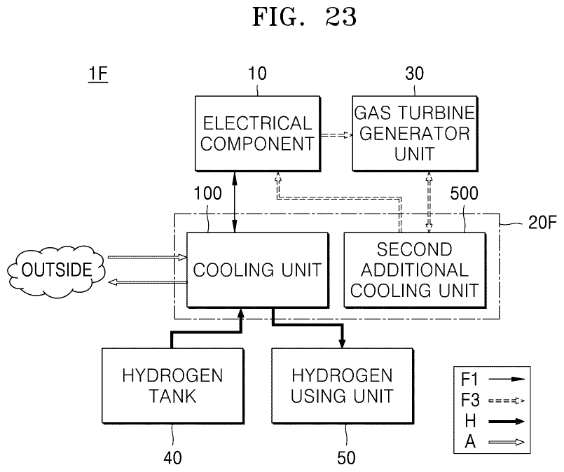

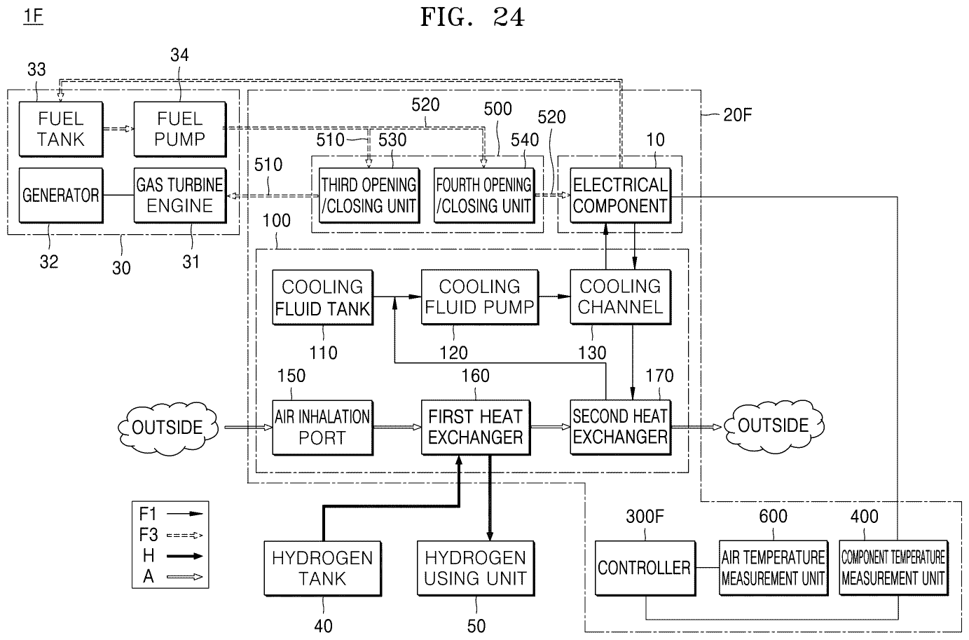

FIG. 23 is a conceptual diagram schematically illustrating a thermal management apparatus 20F for an electric propulsion aircraft according to another embodiment. FIG. 24 illustrates connections between particular components of the thermal management apparatus 20F of FIG. 23.

An electric propulsion aircraft 1F may use not only the electric energy stored in a battery but also the electric energy produced by the operation of a gas turbine, as a power source. That is, the electric propulsion aircraft 1F may include a gas turbine hybrid electric propulsion aircraft.

Referring to FIG. 23, an electric propulsion aircraft 1F may include an electrical component 10, a hydrogen tank 40, a hydrogen using unit 50, a thermal management apparatus 20F for an electric propulsion aircraft, and a gas turbine generator unit 30. Among them, the electrical component 10, the hydrogen tank 40, the hydrogen using unit 50, the cooling unit 600 of the thermal management apparatus 20F, the air temperature measurement unit 600, and the component temperature measurement unit 400 may be the same as or similar to those described in the electric propulsion aircraft 1D described above, and thus, redundant descriptions thereof will be omitted and differences therebetween will be mainly described. The same reference numerals may be used in FIGS. 23 and 24 with respect to all of the same components as those of the electric propulsion aircraft 1D illustrated in FIGS. 16 to 18.

The gas turbine generator unit 30 may convert chemical energy of fuel into electric energy. The gas turbine generator unit 30 may be the same as or similar to that described in FIG. 11, and thus, redundant descriptions thereof will be omitted for conciseness.

By removing heat generated during operation of the electrical component 10, the thermal management apparatus 20F may manage and control a temperature of the electrical component 10 such that the temperature is maintained within an operation temperature range. Referring to FIG. 24, the thermal management apparatus 20F may include a cooling unit 100, a controller 300F, an air temperature measurement unit 600, a component temperature measurement unit 400, and a second additional cooling unit 500.

The second additional cooling unit 500 may cool the electrical component 10 by using the third cooling fluid F3. The third cooling fluid F3 may include fuel used in the gas turbine engine 31. That is, the second additional cooling unit 500 may additionally cool the electrical component 10 by using fuel used in the gas turbine generator unit 30. The second additional cooling unit 500 may be the same as or similar to that described in FIG. 11, and thus, redundant descriptions thereof will be omitted for conciseness.

The controller 300F may control the operation of the thermal management apparatus 20F. The controller 300F may control the flow of the third cooling fluid F3 by operating the third opening/closing unit 530 and the fourth opening/closing unit 540. The controller 300F may determine whether to operate the second additional cooling unit 500, depending on the flight situation of the electric propulsion aircraft 1F.

That is, the controller 300F may control the operation of the thermal management apparatus 20F such that the first cooling fluid F1 and the third cooling fluid F3 may cool the electrical component 10 together in the first situation S1. That is, in the first situation S1, the controller 300F may close the third opening/closing unit 530 and open the fourth opening/closing unit 540.

The first situation S1 described above may be a situation in which the electric propulsion aircraft 1F is mainly close to the ground. Because the gas turbine engine 31 generates excessive noise during operation, the electric propulsion aircraft 1F may use only the electric energy stored in the battery, as a power source in the first situation S1 in which the electric propulsion aircraft 1F is mainly close to the ground.

That is, in the first situation S1, the controller 300F may stop the operation of the gas turbine engine 31 by closing the third opening/closing unit 530 to prevent the third cooling fluid F3, that is, fuel, from being supplied to the gas turbine engine 31. Simultaneously, in the first situation S1, the controller 300F may cool the electrical component 10 by the third cooling fluid F3 by opening the fourth opening/closing unit 540 to supply the third cooling fluid F3 to the electrical component 10.

Moreover, the controller 300F may open the third opening/closing unit 530 in a second situation S2. The second situation S2 described above may be a situation in which the electric propulsion aircraft 1F is located in the sky above from the ground. That is, because noise is not a problem in the second situation S2, the electric propulsion aircraft 1F may use the electric energy produced by the gas turbine generator unit 30, as a power source in the second situation S2 together with the electric energy stored in the battery.

That is, in the second situation S2, the controller 300F may supply the third cooling fluid F3, that is, fuel, to the gas turbine engine 31 by opening the third opening/closing unit 530, and the gas turbine generator unit 30 may produce electric energy.

The controller 300F may control the third opening/closing unit 530 and the fourth opening/closing unit 540 based on the temperature value of the electrical component 10. The controller 300F may be electrically connected to the component temperature measurement unit 400. The controller 300F may receive the measured temperature value from the component temperature measurement unit 400.

When the temperature value of the electrical component 10 is higher than a preset temperature, the controller 300F may close the third opening/closing unit 530 and open the fourth opening/closing unit 540.

When the temperature of the electrical component 10 is higher than a set temperature, cooling by the first cooling fluid F1 of the cooling unit 100 alone may be insufficient to cool the electrical component 10. Thus, the controller 300F may additionally cool the electrical component 10 by opening the fourth opening/closing unit 540 to allow the third cooling fluid F3 to flow to the electrical component 10.

Moreover, when the temperature of the electrical component 10 is higher than the set temperature, it may be a situation in which more power is required for the electric propulsion aircraft 1F. This situation may include the first situation S1 described above, the first situation S1 may be a situation in which the electric propulsion aircraft 1F is mainly close to the ground. Thus, in this case, the controller 300F may close the third opening/closing unit 530 such that the third cooling fluid F3 is used only to cool the electrical component 10. Accordingly, the electrical component 10 may be rapidly cooled.

The controller 300F may open the third opening/closing unit 530 after a certain time from when the electric propulsion aircraft 1F takes off. The certain time may be determined as the average time from when the electric propulsion aircraft 1F starts operating to when the electric propulsion aircraft 1F switches from take-off mode to cruise mode. That is, the flight situation of the electric propulsion aircraft 1F after a certain time from when the electric propulsion aircraft 1F takes off may include the second situation S2 described above.

In the second situation S2, because the electric propulsion aircraft 1F is not close to the ground, noise may not be a problem. Thus, from this time, the electric propulsion aircraft 1F may use the electric energy produced by the gas turbine generator unit 30, as a power source together with the electric energy stored in the battery.

That is, the controller 300F may supply the third cooling fluid F3, that is, fuel, to the gas turbine engine 31 by opening the third opening/closing unit 530 after a certain time from when the electric propulsion aircraft 1F takes off, and the gas turbine generator unit 30 may produce electric energy.

Moreover, the controller 300F may include the controller 300D described in the electric propulsion aircraft 1D described above. That is, the controller 300F may control the flow rate of the air inhalation port 150 based on the air temperature value measured by the air temperature measurement unit 600 or the temperature value of the electrical component 10 measured by the component temperature measurement unit 400.

In the thermal management apparatus 20F, because the first heat exchanger 160 functions as a vaporizer and thus it is not necessary to arrange a separate vaporizer, the configuration of the electric propulsion aircraft 1F may be simplified and the weight thereof may be reduced to improve the performance thereof. Also, because the outside air A is supplied to the second heat exchanger 170 in the state of being lowered in temperature by passing through the first heat exchanger 160, the heat exchange performance of the second heat exchanger 170 may be improved and the cooling performance of the cooling unit 100 may also be improved.

Also, because the weight and volume of the cooling unit 100 may be designed and produced for the second situation S2 requiring less power than the first situation S1, the weight and volume of the electric propulsion aircraft 1F may be reduced to improve the performance of the electric propulsion aircraft 1F.

Moreover, because the thermal management apparatus 20F uses, for cooling, the third cooling fluid F3 mounted on the electric propulsion aircraft 1F, that is, the fuel used in the gas turbine engine 31, it may be economical in that the cooling capacity may be increased without additional complex equipment, except for allowing the fuel to flow to the electrical component 10 by diverging from the movement path of the fuel.

The performance of the gas turbine engine 31 may be improved as the temperature of the fuel supplied to the gas turbine engine 31 increases. The thermal management apparatus 20F may use the third cooling fluid F3, that is, fuel, to cool the electrical components 10. The temperature of the fuel may increase by receiving heat from the electrical components 10. Thus, the thermal management apparatus 20F may supply, to the gas turbine engine 31, the third cooling fluid F3, the temperature of which has increased by cooling the electrical component 10, thereby improving the performance of the gas turbine engine 31.

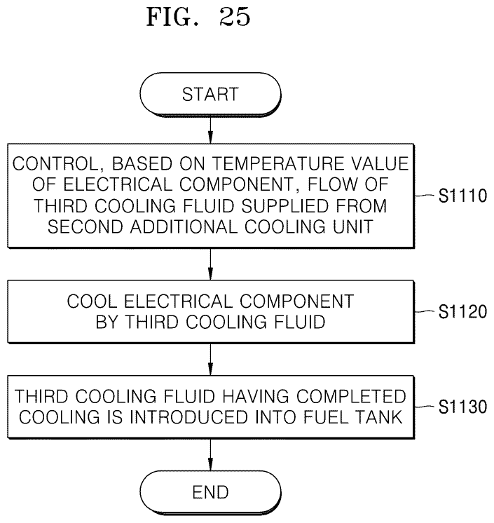

FIG. 25 is a flowchart illustrating operations that may be added to the thermal management method M1 of FIG. 19 when a thermal management apparatus 20F for an electric propulsion aircraft includes a second additional cooling unit 500.

Referring to FIG. 25, in the case of using the thermal management apparatus 20F including the second additional cooling unit 500, the thermal management method M1 may further include operation S1110 of the controller 300F controlling the flow of the third cooling fluid F3 supplied from the second additional cooling unit 500, based on the temperature value of the electrical component 10, operation S1120 of cooling the electrical component 10 by using the third cooling fluid F3, and operation S1130 of introducing the third cooling fluid F3 having completed cooling, into the fuel tank 33.

In operation S1110 of controlling the flow of the third cooling fluid F3, the controller 300F may close the third opening/closing unit 530 arranged on the power generation flow path 510 and open the fourth opening/closing unit 540 arranged on the additional cooling flow path 520, when the temperature value of the electrical component 10 is higher than a preset temperature. When the temperature of the electrical component 10 is higher than or equal to the set temperature, it may be a situation in which more power is required for the electric propulsion aircraft 1F. This situation may include the first situation S1 described above.

In operation S1110 of controlling the flow of the third cooling fluid F3, the controller 300F may open the third opening/closing unit 530 after a certain time from when the electric propulsion aircraft 1F takes off. The flight situation of the electric propulsion aircraft 1F after a certain time from when the electric propulsion aircraft 1F takes off may include the second situation S2 described above.

Operation S1120 of cooling by using the third cooling fluid F3 may be performed when the temperature value of the electrical component 10 is higher than a preset temperature. Operation S1120 may be mainly performed in the first situation S1 described above.

In operation S1130 of introducing the third cooling fluid F3 into the fuel tank 33, the third cooling fluid F3 having completed cooling may be introduced into the fuel tank 33. The fuel stored in the fuel tank 33 may be supplied to the gas turbine engine 31. That is, the third cooling fluid F3, the temperature of which has increased by cooling the electrical component 10, may be supplied to the gas turbine engine 31. The performance of the gas turbine engine 31 may be improved as the temperature of the fuel supplied to the gas turbine engine 31 increases. Thus, the performance of the gas turbine engine 31 may be improved by operation S1130.

Referring to FIGS. 19 and 25, in the thermal management method M1, the operations S1110 to S1130 may be performed simultaneously with the operations S1020 to S1070 described in FIG. 19, regardless of the time sequence.

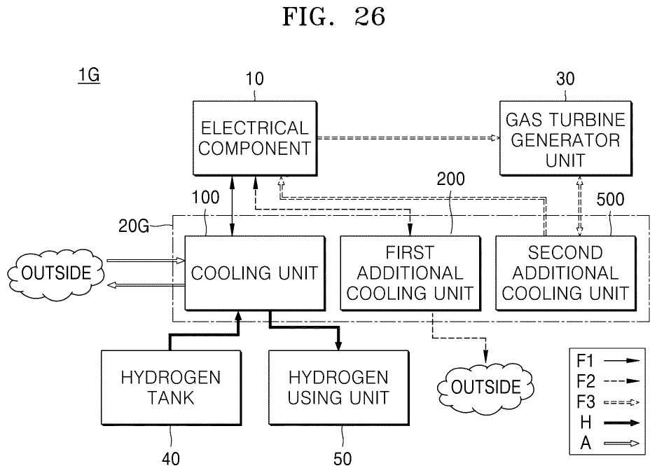

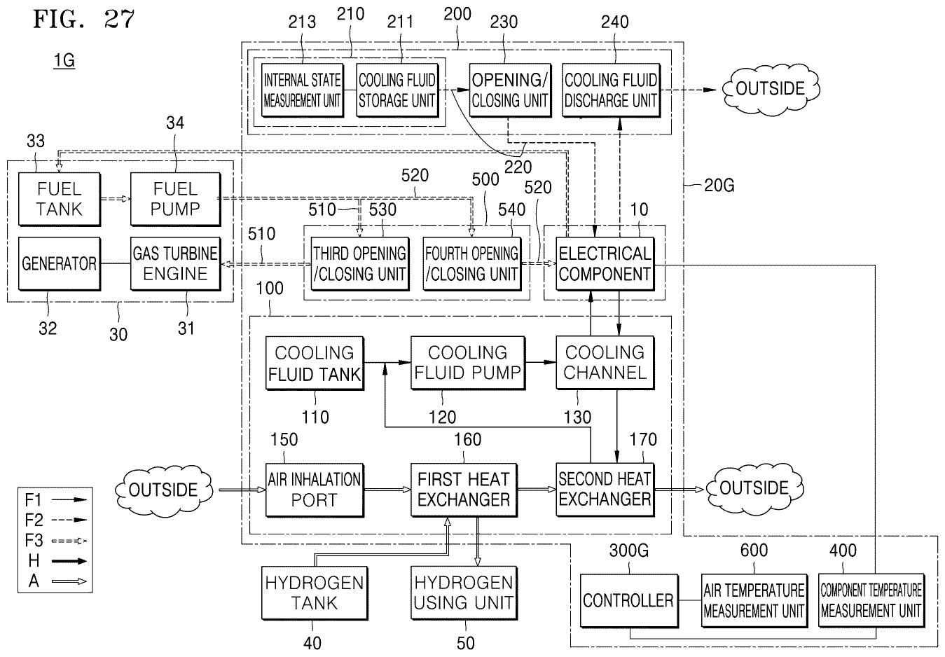

FIG. 26 is a conceptual diagram schematically illustrating a thermal management apparatus 20G for an electric propulsion aircraft according to another embodiment. FIG. 27 illustrates connections between particular components of the thermal management apparatus 20G of FIG. 26.

An electric propulsion aircraft 1G may use not only the electric energy stored in a battery but also the electric energy produced by the operation of a gas turbine, as a power source. That is, the electric propulsion aircraft 1G may include a gas turbine hybrid electric propulsion aircraft.

Referring to FIG. 26, the electric propulsion aircraft 1G may include an electrical component 10, a hydrogen tank 40, a hydrogen using unit 50, a thermal management apparatus 20G for an electric propulsion aircraft, and a gas turbine generator unit 30. Among them, the electrical component 10, the hydrogen tank 40, the hydrogen using unit 50, the gas turbine generator unit 30, the cooling unit 100 of the thermal management apparatus 20G, the air temperature measurement unit 600, the component temperature measurement unit 400, the first additional cooling unit 200, and the second additional cooling unit 500 may be the same as or similar to those described in the electric propulsion aircrafts 1A, 1B, and 1F described above, and thus, redundant descriptions thereof will be omitted and differences therebetween will be mainly described. The same reference numerals may be used in FIGS. 26 and 27 with respect to all of the same components as those of the electric propulsion aircrafts 1A, 1B, and 1F illustrated in FIGS. 16 to 24.

By removing heat generated during operation of the electrical component 10, the thermal management apparatus 20G may manage and control a temperature of the electrical component 10 such that the temperature is maintained within an operation temperature range. Referring to FIG. 27, the thermal management apparatus 20G may include a cooling unit 100, a controller 300G, an air temperature measurement unit 600, a component temperature measurement unit 400, a first additional cooling unit 200, and a second additional cooling unit 500.

The controller 300G may include all of the controllers 300A, 300B, and 300F described in the electric propulsion aircrafts 1A, 1B, and 1F described above.

That is, the controller 300G may control the flow rate of the air inhalation port 150 based on the air temperature value measured by the air temperature measurement unit 600 or the temperature value of the electrical component 10 measured by the component temperature measurement unit 400.

Moreover, in the first situation S1 described above, the controller 300G may cool the electrical component 10 by additionally operating the first additional cooling unit 200 and the second additional cooling unit 500 in addition to the cooling unit 100. That is, the controller 300G may control the operation of the thermal management apparatus 20G such that the first cooling fluid F1, the second cooling fluid F2, and the third cooling fluid F3 may cool the electrical component 10 together in the first situation S1.

Also, the controller 300G may control the opening/closing unit 230, the third opening/closing unit 530, and the fourth opening/closing unit 540 based on the temperature value of the electrical component 10 measured by the component temperature measurement unit 400.

In the thermal management apparatus 20G, because the first heat exchanger 160 functions as a vaporizer and thus it is not necessary to arrange a separate vaporizer, the configuration of the electric propulsion aircraft 1G may be simplified and the weight thereof may be reduced to improve the performance thereof. Also, because the outside air A is supplied to the second heat exchanger 170 in the state of being lowered in temperature by passing through the first heat exchanger 160, the heat exchange performance of the second heat exchanger 170 may be improved and the cooling performance of the cooling unit 100 may also be improved.

Also, because the weight and volume of the cooling unit 100 may be designed and produced for the second situation S2 requiring less power than the first situation S1, the weight and volume of the electric propulsion aircraft 1G may be reduced to improve the performance of the electric propulsion aircraft 1G.

Moreover, the thermal management apparatus 20G may be economical because the fuel used in the gas turbine engine 31 is used for cooling. Also, the thermal management apparatus 20G may supply, to the gas turbine engine 31, the third cooling fluid F3, the temperature of which has increased by cooling the electrical component 10, thereby improving the performance of the gas turbine engine 31.

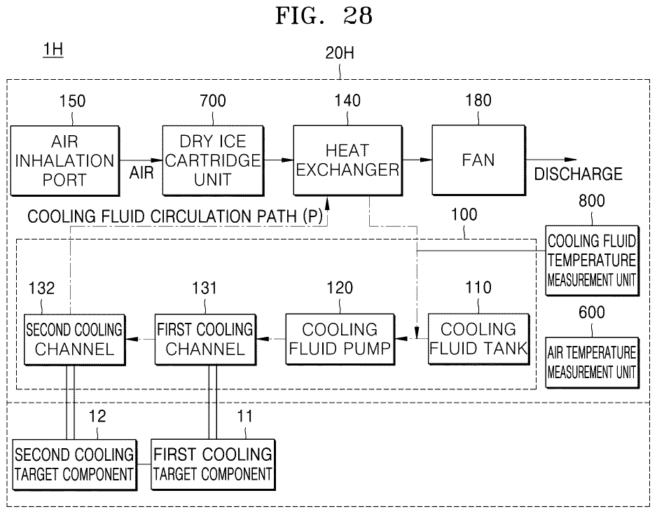

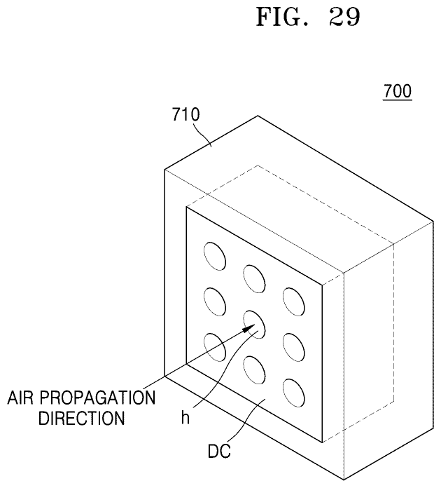

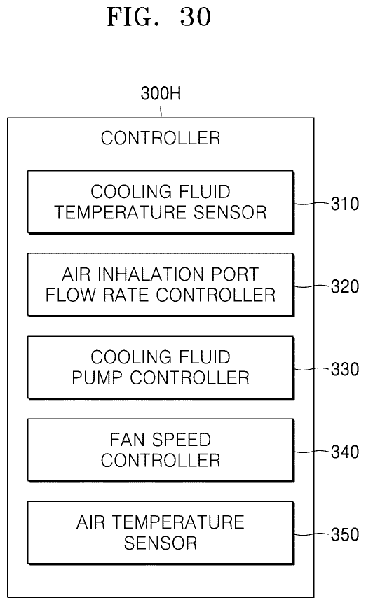

FIG. 28 illustrates connections between particular components of a thermal management apparatus 20H for an electric propulsion aircraft according to another embodiment. FIG. 29 illustrates a schematic shape of a dry ice cartridge unit 700 according to embodiments. FIG. 30 illustrates a controller 300H according to an embodiment.

Referring to FIG. 28, the thermal management apparatus 20H may include a heat exchanger 140, an air inhalation port 150 for inhaling outside air into the thermal management apparatus and transmits the same to the heat exchanger 140, and a dry ice cartridge DC which is arranged between the heat exchanger 140 and the air inhalation port 150 and through which air introduced through the air inhalation port 150 passes.

The thermal management apparatus 20H may include an air inhalation port 150. The air inhalation port 150 may introduce the air outside the electric propulsion aircraft into the thermal management apparatus 20H. The outside air introduced through the air inhalation port 150 may pass through the dry ice cartridge unit 700 and then may be introduced into the heat exchanger 140.

The thermal management apparatus 20H may include a dry ice cartridge unit 700 which is arranged between the heat exchanger 140 and the air inhalation port 150 and through which air introduced through the air inhalation port 150 passes.

Referring to FIG. 29, the dry ice cartridge unit 700 may include a dry ice cartridge DC and an installation unit 710 to which the dry ice cartridge DC is fixed. The installation unit 710 may include a fixing structure for fixing the dry ice cartridge DC to the installation unit 710. The dry ice cartridge DC may include a plurality of holes h formed to pass through the dry ice cartridge DC. The pass-through direction of the plurality of holes h may be the air propagation direction, the dry ice cartridge DC may be arranged on the path through which air propagates from the air inhalation port 150 to the heat exchanger 140, and the pass-through direction of the plurality of holes h of the dry ice cartridge DC may be parallel to the direction in which air propagates from the air inhalation port 150 to the heat exchanger 140.

The air introduced through the air inhalation port 150 may undergo a temperature decrease due to heat conduction and sublimation while passing through the dry ice cartridge unit 700. Accordingly, the temperature of air introduced into the heat exchanger 140 after passing through the dry ice cartridge unit 700 may be lower than the temperature of air directly introduced into the heat exchanger 140 from the outside.

When the air lowered in temperature after passing through the dry ice cartridge unit 700 passes through the heat exchanger 140, the cooling efficiency of the cooling fluid on a cooling fluid circulation path P may be further improved compared to when the outside air directly passes through the heat exchanger 140. The air heated after passing through the heat exchanger 140 may be discharged back to the outside of the electric propulsion aircraft through a fan 180.

The cooling unit 100 including the cooling fluid circulation path P may include a cooling fluid tank 110 for supplying a cooling fluid to the cooling fluid circulation path P, a cooling fluid pump 120 for allowing the cooling fluid to flow along the cooling fluid circulation path P when the cooling fluid is supplied to the cooling fluid circulation path P through the cooling fluid tank 110, a first cooling channel 131 for cooling heat generated from the first cooling target component 11, and a second cooling channel 133 for cooling heat generated from the second cooling target component 12. The cooling fluid circulation path P may be connected to the heat exchanger 140, and thus, the cooling fluid heated while passing through the first cooling channel 131 and the second cooling channel 133 may be recooled through heat exchange in the heat exchanger 140.

According to the present embodiment, the temperature of air introduced into the heat exchanger 140 may be further cooled through the dry ice cartridge unit 700, thereby improving the heat exchange performance of the heat exchanger 140.

As cooling air is supplied to the heat exchanger 140, the heat exchange performance of the heat exchanger 140 may be improved, thereby reducing the power required for heat exchange in the thermal management apparatus 20H and reducing the output of the cooling fluid pump or reducing the fan output.

Because the dry ice cartridge DC is a consumable material, it may sublimate with continued use and thus the weight of the dry ice cartridge DC may decrease gradually. Thus, as the flight time of the electric propulsion aircraft lapses, the weight of the dry ice cartridge DC may decrease and thus the overall weight of the electric propulsion aircraft may decrease, thereby securing the fuel efficiency during the flight of the electric propulsion aircraft.

Particularly, by using more dry ice cartridges DC in the period such as the take-off, transition, or ascent period of FIG. 7 requiring more initial power than the cruise period of FIG. 7, the weight of the electric propulsion aircraft may be further reduced when the cruise point is reached, thereby securing the fuel efficiency of the electric propulsion aircraft.

According to the present embodiment, the thermal management apparatus 20H may include a cooling fluid temperature measurement unit 800 for measuring the temperature of the cooling fluid flowing through the cooling fluid circulation path P connected to the heat exchanger 140. The thermal management apparatus 20H may further include an air temperature measurement unit 600 for sensing the air temperature.

Also, according to the present embodiment, the thermal management apparatus 20H may further include a controller 300H for controlling the operation of the thermal management apparatus 20H, and the controller 300H may include a cooling fluid temperature sensor 310 for sensing the cooling fluid temperature of the thermal management apparatus 20H through the cooling fluid temperature measurement unit 800, and an air temperature sensor 350 for sensing the air temperature through the air temperature measurement unit 600.

The controller 300H may further include an air inhalation port flow rate controller 320 for controlling the flow rate of the air inhalation port based on the cooling fluid temperature value sensed by the cooling fluid temperature sensor 310. When the cooling fluid temperature is lower than a preset reference temperature, the flow rate of the air inhalation port may be reduced to save the power required for the heat exchanger 140. Conversely, when the cooling fluid temperature is higher than the preset reference temperature, the flow rate of the air inhalation port may be increased to increase the sublimation amount of the dry ice cartridge DC and the flow rate of air introduced into the heat exchanger 140 may be increased to increase the heat transmission amount of the heat exchanger 140, thereby enabling a greater amount of heat exchange in the heat exchanger 140.

The controller 300H may further include a cooling fluid pump controller 330 for controlling the cooling fluid pump 120 for causing the cooling fluid to flow, based on the cooling fluid temperature value sensed by the cooling fluid temperature sensor 310. When the cooling fluid temperature is lower than the preset reference temperature, the cooling fluid pump 120 may be more slowly operated to save the power required for the cooling fluid pump 120. Conversely, when the cooling fluid temperature is higher than the preset reference temperature, the cooling fluid pump 120 may be more quickly operated to lower the temperature of the cooling fluid.

The controller 300H may further include a fan speed controller 340 for controlling the rotation speed of the fan 180 for discharging the air introduced through the air inhalation port 150, after heat exchange, based on the cooling fluid temperature value sensed by the cooling fluid temperature sensor 310. When the cooling fluid temperature is lower than the preset reference temperature, the fan 180 may be more slowly rotated to save the power required for the fan 180. Conversely, when the cooling fluid temperature is higher than the preset reference temperature, the fan 180 may be more quickly rotated to more quickly discharge the heat-exchanged air to further promote the circulation of air entering and exiting the thermal management apparatus 20H, thereby further lowering the temperature of the cooling fluid through heat exchange.

The controller 300H may further include a fan speed controller 340 for controlling the rotation speed of the fan 180 for discharging the air introduced through the air inhalation port 150, after heat exchange, based on the air temperature value sensed by the air temperature sensor 350. As the rotation speed of the fan 180 increases, the amount of air introduced through the air inhalation port 150 may increase.

By adjusting the rotation speed of the fan 180 according to the air temperature, the controller 300H may adjust the temperature of the air introduced into the heat exchanger 140. That is, when the air temperature is relatively higher than a preset temperature, the speed of the fan 180 may be reduced to reduce the amount of air introduced from the air. On the other hand, when the air temperature is lower than the preset temperature, the speed of the fan 180 may be increased to increase the amount of air introduced from the air.

Referring to FIG. 7, the thermal management apparatus 20H may be effective when the thermal management of heat generated by the electric propulsion aircraft is not properly performed under the condition of high air temperature. In this case, the thermal management apparatus 20H may operate throughout the entire period from take-off to landing by controlling the flow rate through the air inhalation port 150. However, the amount of heat generated may be greater in the period in which the electric propulsion aircraft takes off, transitions, and ascends and the period in which the electric propulsion aircraft descends, transitions, and lands than in the cruise period. This may be because the amount of power required for the battery, inverter, or motor is greater in the take-off, transition, and ascent period and the descent, transition, and landing period than in the cruise period. Thus, the thermal management apparatus 20H may be operated with priority in the period in which the electric propulsion aircraft takes off, transitions, and ascends and the period in which the electric propulsion aircraft descends, transitions, and lands. That is, the thermal management apparatus 20H may be configured to operate more in the vertical movement period than in the horizontal movement period of the electric propulsion aircraft.

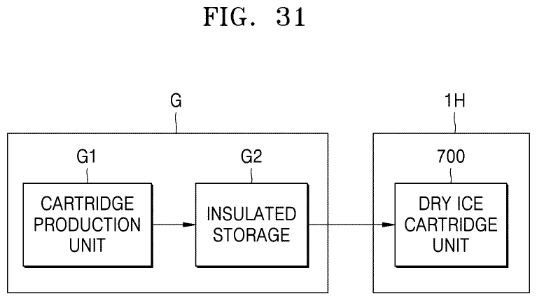

FIG. 31 illustrates a dry ice cartridge transfer process according to embodiments.

Referring to FIG. 31, in the dry ice cartridge transfer process, a dry ice cartridge DC may be produced by a cartridge production unit G1 on a ground G. Thereafter, the dry ice cartridge DC may be transferred and stored in an insulated storage G2 cooled by a vacuum layer.

Thereafter, immediately before the take-off of an electric propulsion aircraft 1H, the dry ice cartridge DC may be installed in the installation unit 710 of the dry ice cartridge unit 700 of the electric propulsion aircraft 1H.

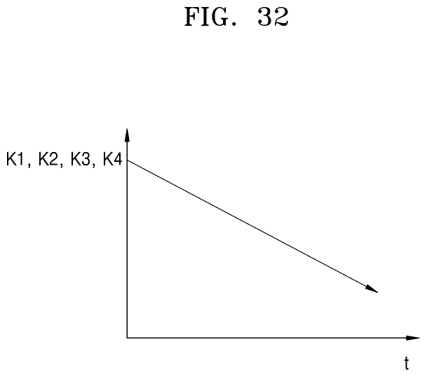

FIG. 32 is a graph schematically illustrating a state in which a dry ice weight K1, a thermal management apparatus power consumption K2, a cooling fluid pump output K3, and a fan output K3 decrease over the operation time of a thermal management apparatus 20H for an electric propulsion aircraft according to another embodiment.

According to the present embodiment, the dry ice weight K1, the thermal management apparatus power consumption K2, the cooling fluid pump output K3, and the fan output K3 may decrease gradually over the operation time t of the thermal management apparatus 20H. As the weight of the dry ice decreases, the electric propulsion aircraft may gradually become lighter, thereby reducing the power consumption during the operation of the electric propulsion aircraft. Also, because the cold air having passed through the dry ice cartridge unit 700 is introduced into the heat exchanger 140 and thus the heat exchange efficiency of the heat exchanger 140 increases gradually, the power consumed for operating the heat exchanger 140 may be gradually reduced. Likewise, because the cold air having passed through the dry ice cartridge unit 700 is introduced into the heat exchanger 140 and thus the heat exchange efficiency of the heat exchanger 140 increases gradually, the output of the cooling fluid pump 120 and the fan 180 may be gradually reduced because the heat exchange performance may be secured even when the output of the cooling fluid pump 120 and the fan 180 is reduced.

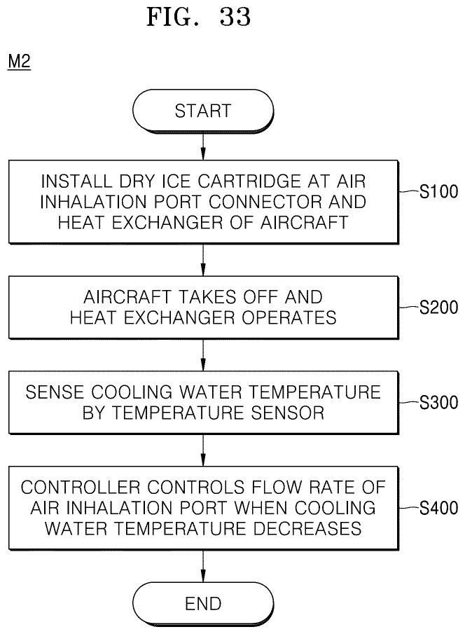

FIG. 33 is a flowchart illustrating a thermal management method M2 for an electric propulsion aircraft according to another embodiment.

Referring to FIG. 33, the thermal management method M2 may include operation S100 of installing a dry ice cartridge at an air inhalation port connector and a heat exchanger of the electric propulsion aircraft, operation S200 in which the electric propulsion aircraft takes off and the heat exchanger operates, operation S300 of the cooling fluid temperature measurement unit sensing the cooling fluid temperature, and operation S400 of the controller controlling the flow rate of the air inhalation port when the cooling fluid temperature decreases.

Also, according to the present embodiment, after the operation in which the heat exchanger operates, the thermal management method M2 may further include operation S500 in which the air temperature measurement unit senses the air temperature and the rotation speed of the fan for discharging air after heat exchange is controlled based on the sensed air temperature value.

Also, according to the present embodiment, after the operation in which the heat exchanger operates, the thermal management method M2 may further include operation S600 in which the controller controls the cooling fluid pump when the cooling fluid temperature decreases.

Also, according to the present embodiment, after the operation in which the heat exchanger operates, the thermal management method M2 may further include operation S700 in which the controller controls the rotation speed of the fan when the cooling fluid temperature decreases.

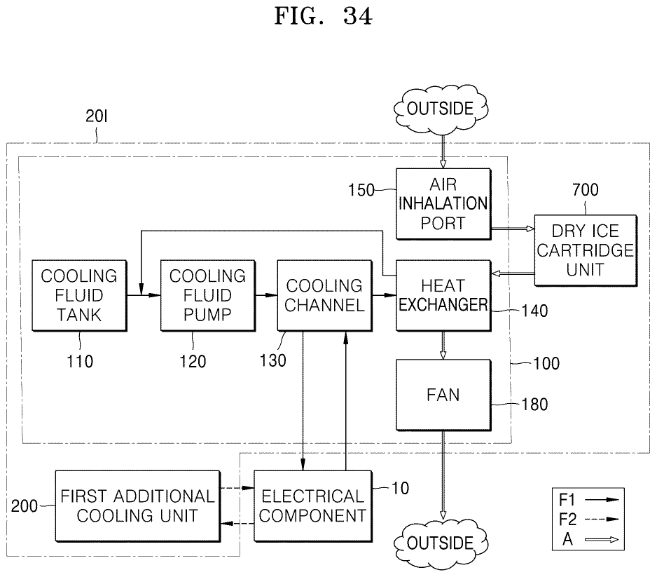

FIGS. 34 to 40 schematically illustrate a flow of a fluid in thermal management apparatuses 20I, 20J, 20K, 20L, 20M, 20N, and 20P for an electric propulsion aircraft according to embodiments.

Referring to FIG. 34, the thermal management apparatus 20I may include a cooling unit 100, a first additional cooling unit 200, and a dry ice cartridge unit 700. The cooling unit 100, the first additional cooling unit 200, and the dry ice cartridge unit 700 may be the same as or similar to those described above, and thus, redundant descriptions thereof will be omitted for conciseness.

The first additional cooling unit 200 may cool the electrical component 10 by using the second cooling fluid F2. Moreover, the air A introduced from the outside of the electric propulsion aircraft may be introduced through the air inhalation port 150 and then discharged back to the outside through the fan 180 after sequentially passing through the dry ice cartridge unit 700 and the heat exchanger 140. The temperature of the air A introduced into the heat exchanger 140 after passing through the dry ice cartridge unit 700 may be formed lower, thereby improving the cooling efficiency of the cooling fluid.

The thermal management apparatus 20I may efficiently cool the electrical component 10 by including the first additional cooling unit 200 and the dry ice cartridge unit 700.

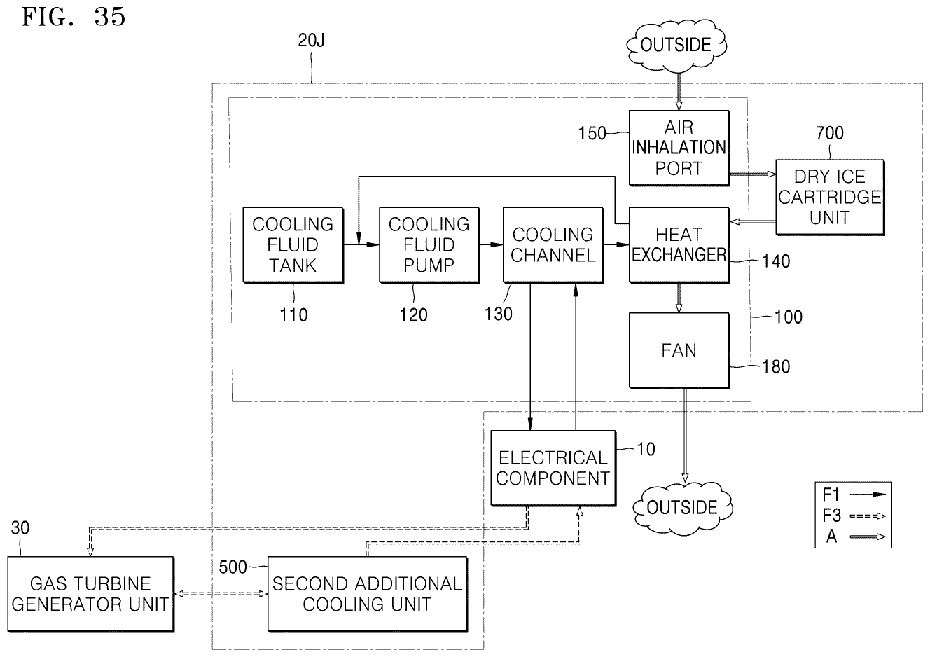

Referring to FIG. 35, the thermal management apparatus 20J may include a cooling unit 100, a second additional cooling unit 500, and a dry ice cartridge unit 700. The cooling unit 100, the second additional cooling unit 500, and the dry ice cartridge unit 700 may be the same as or similar to those described above, and thus, redundant descriptions thereof will be omitted for conciseness.

The second additional cooling unit 500 may cool the electrical component 10 by using the third cooling fluid F3. Moreover, the air A introduced from the outside of the electric propulsion aircraft may be introduced through the air inhalation port 150 and then discharged back to the outside through the fan 180 after sequentially passing through the dry ice cartridge unit 700 and the heat exchanger 140. The temperature of the air A introduced into the heat exchanger 140 after passing through the dry ice cartridge unit 700 may be formed lower, thereby improving the cooling efficiency of the cooling fluid.

The thermal management apparatus 20J may improve not only the performance of the gas turbine engine but also the thermal management efficiency of the electrical components 10 by including the second additional cooling unit 500 and the dry ice cartridge unit 700.

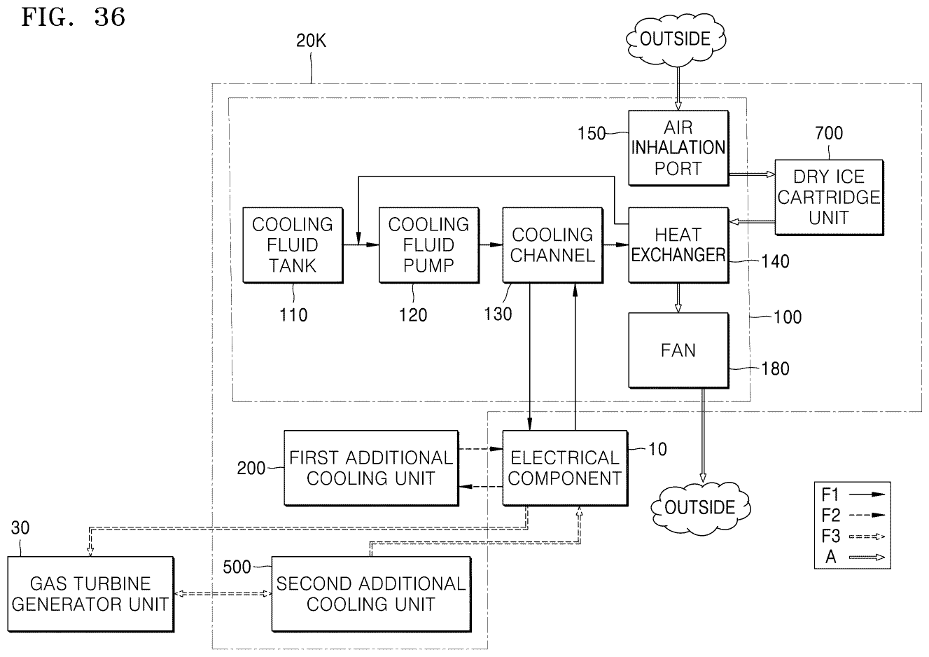

Referring to FIG. 36, the thermal management apparatus 20K may include a cooling unit 100, a first additional cooling unit 200, a second additional cooling unit 500, and a dry ice cartridge unit 700. The cooling unit 100, the first additional cooling unit 200, the second additional cooling unit 500, and the dry ice cartridge unit 700 may be the same as or similar to those described above, and thus, redundant descriptions thereof will be omitted for conciseness.

The first additional cooling unit 200 may cool the electrical component 10 by using the second cooling fluid F2. The second additional cooling unit 500 may cool the electrical component 10 by using the third cooling fluid F3. Moreover, the air A introduced from the outside of the electric propulsion aircraft may be introduced through the air inhalation port 150 and then discharged back to the outside through the fan 180 after sequentially passing through the dry ice cartridge unit 700 and the heat exchanger 140. The temperature of the air A introduced into the heat exchanger 140 after passing through the dry ice cartridge unit 700 may be formed lower, thereby improving the cooling efficiency of the cooling fluid.

The thermal management apparatus 20K may improve not only the performance of the gas turbine engine but also the thermal management efficiency of the electrical components 10 by including the first additional cooling unit 200, the second additional cooling unit 500, and the dry ice cartridge unit 700.

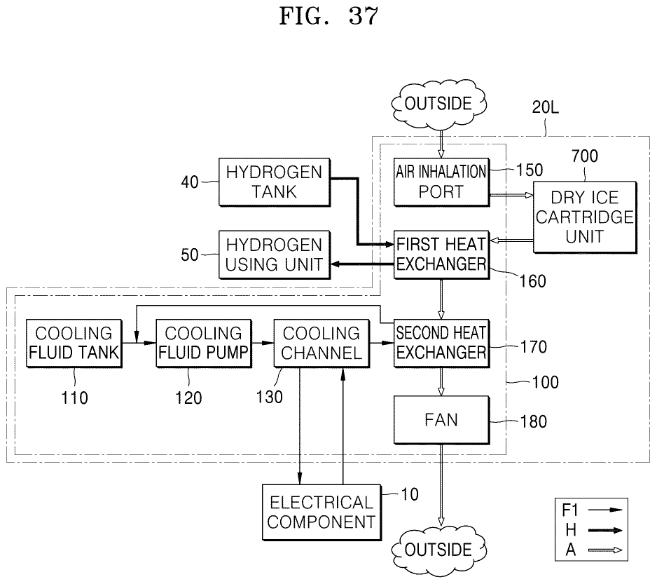

Referring to FIG. 37, the thermal management apparatus 20L may include a cooling unit 100 and a dry ice cartridge unit 700. Also, the cooling unit 100 may include a first heat exchanger 160 and a second heat exchanger 170. The cooling unit 100, the first heat exchanger 160, the second heat exchanger 170, and the dry ice cartridge unit 700 may be the same as or similar to those described above, and thus, redundant descriptions thereof will be omitted for conciseness.

In the first heat exchanger 160, hydrogen H supplied from the hydrogen tank 40 and air A supplied from the air inhalation port 150 may exchange heat with each other. Moreover, as illustrated in FIG. 37, the dry ice cartridge unit 700 may be arranged between the air inhalation port 150 and the first heat exchanger 160. In another embodiment, the dry ice cartridge unit 700 may be arranged between the air inhalation port 150 and the second heat exchanger 170 (not illustrated). The temperature of the air A introduced into the first heat exchanger 160 or the second heat exchanger 170 after passing through the dry ice cartridge unit 700 may be formed lower, thereby improving the cooling efficiency of the cooling fluid.

By lowering the temperature of the air A by using the hydrogen H and the dry ice cartridge unit 700, the thermal management apparatus 20K may improve the heat exchange performance, thereby improving the cooling performance of the cooling unit 100.

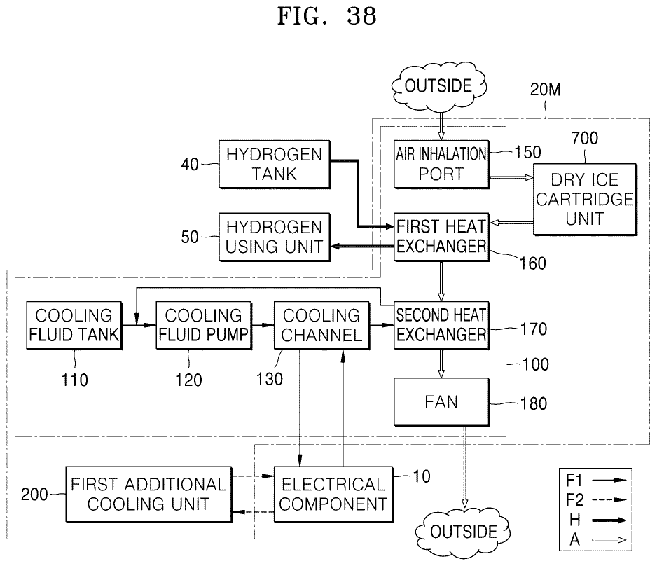

Referring to FIG. 38, the thermal management apparatus 20M may include a cooling unit 100, a first additional cooling unit 200, and a dry ice cartridge unit 700.

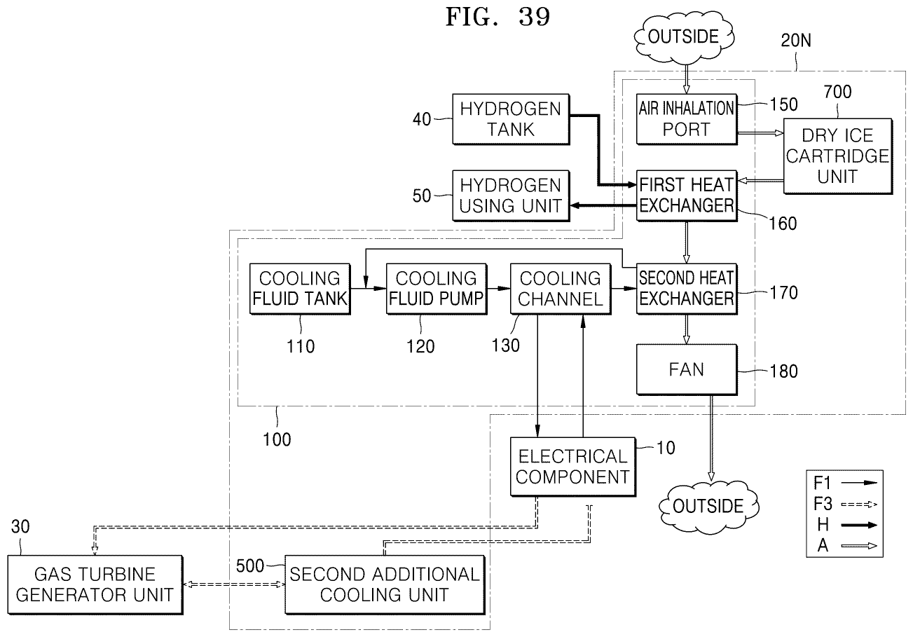

Referring to FIG. 39, the thermal management apparatus 20N may include a cooling unit 100, a second additional cooling unit 500, and a dry ice cartridge unit 700.

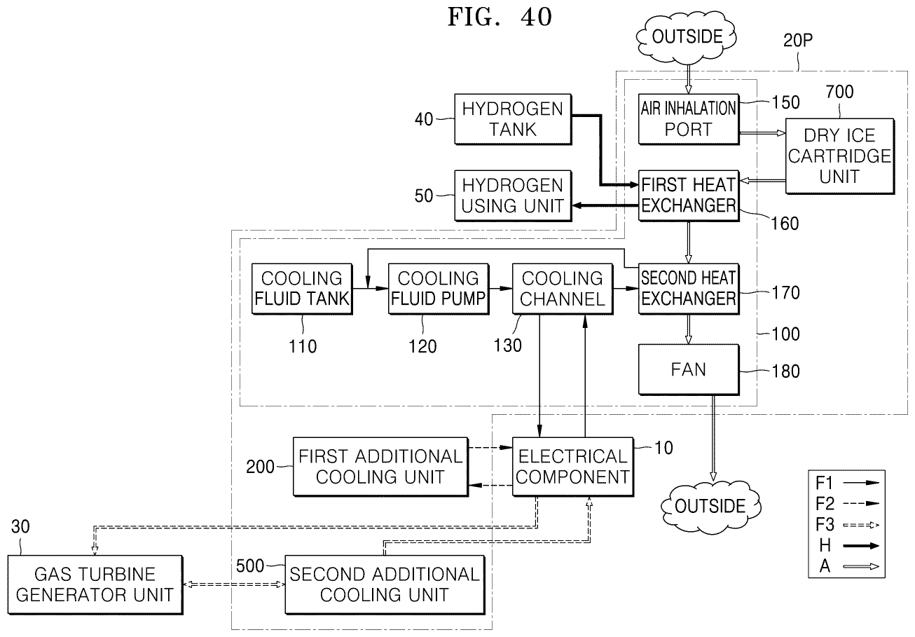

Referring to FIG. 40, the thermal management apparatus 20P may include a cooling unit 100, a first additional cooling unit 200, a second additional cooling unit 500, and a dry ice cartridge unit 700.

Moreover, the thermal management apparatuses 20M, 20N, and 20P may include a first heat exchanger 160 in which hydrogen H supplied from the hydrogen tank 40 and air A supplied from the air inhalation port 150 exchange heat with each other.

By lowering the temperature of the air A by using the hydrogen H and the dry ice cartridge unit 700, the thermal management apparatuses 20M, 20N, and 20P may improve the heat exchange performance, thereby improving the cooling performance of the cooling unit 100. Also, the thermal management apparatuses 20N and 20P may improve the performance of the gas turbine engine.

Although the disclosure has been described with reference to embodiments illustrated in the drawings, the embodiments are merely examples. Those of ordinary skill in the art may fully understand that various modifications and other equivalent embodiments may be made from the embodiments. Thus, the true scope of the disclosure should be determined based on the appended claims.

Particular technical contents described in the embodiments are merely examples and do not limit the scope of the embodiments. In order to concisely and clearly describe the disclosure, descriptions of general technologies and configurations of the related art may be omitted. Connections or connection members of lines between the elements illustrated in the drawings may illustratively represent functional connections and/or physical or logical connections and may be represented as various replaceable or additional functional connections, physical connections, or logical connections in an actual apparatus. Also, no element may be essential to the practice of the disclosure unless the element is particularly described as “essential” or “critical”.

In the description and claims, “the” or similar reference words may refer to both the singular and the plural unless otherwise specified. Also, unless otherwise specified herein, recitation of a range of values herein are merely intended to serve as a shorthand method of referring individually to each separate value falling within the range, and each separate value may be incorporated herein as if it was individually recited herein. Also, the operations of the method according to embodiments may be performed in any suitable order unless explicitly or otherwise specified herein. The embodiments are not limited to the described order of the operations. All examples or illustrative terms (e.g., “and/or the like” and “such as”) used herein are merely intended to describe the technical concept of the embodiments in detail, and the scope of the embodiments is not limited by the examples or illustrative terms unless otherwise defined in the appended claims. Also, those of ordinary skill in the art may understand that various modifications, combinations, and changes may be made according to design conditions and factors within the scope of the appended claims or equivalents thereof.

In the thermal management apparatus and method according to embodiments, by designing and producing each component of the cooling unit for the second situation requiring less power than the first situation, the weight and volume of the cooling unit may be reduced compared to those for the first situation, thus reducing the weight and volume of the electric propulsion aircraft to improve the performance of the electric propulsion aircraft.

In the thermal management apparatus and method according to embodiments, the first opening/closing unit and the second opening/closing unit may be independently controlled based on the temperature value of the first cooling target component or the temperature value of the second cooling target component, thereby enabling more efficient and precise thermal management.

In the thermal management apparatus and method according to embodiments, because the third cooling fluid, that is, the fuel used in the gas turbine engine, is used for cooling, it may be economical in that the cooling capacity may be increased without separate complex equipment, except for allowing the fuel to flow to the electrical component by diverging from the movement path of the fuel.

The thermal management apparatus and method according to embodiments may improve the performance of the gas turbine engine by supplying, to the gas turbine engine, the third cooling fluid, a temperature of which has increased by cooling the electrical component.

In the thermal management apparatus and method according to embodiments, because the first heat exchanger functions as a vaporizer and thus it is unnecessary to arrange a separate vaporizer, the configuration of the electric propulsion aircraft may be simplified and the weight thereof may be reduced to improve the. Also, because the outside air is supplied to the second heat exchanger in the state of being lowered in temperature by passing through the first heat exchanger, the heat exchange performance of the second heat exchanger may be improved and the cooling performance of the cooling unit may also be improved.

The thermal management apparatus and method according to embodiments may improve the performance of the heat exchanger and the thermal management efficiency by using the dry ice cartridge to lower the temperature of the air introduced into the heat exchanger.

The effects of the disclosure are not limited to the effects mentioned above, and other effects not mentioned herein may be clearly understood from the specification and the accompanying drawings by those of ordinary skill in the art to which the disclosure belongs.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A thermal management apparatus for an electric propulsion aircraft, the thermal management apparatus comprising:
a first cooling channel configured to receive heat from a first cooling target component;
a second cooling channel configured to receive heat from a second cooling target component;
a heat exchanger in which a first cooling fluid having passed through the first cooling channel and the second cooling channel exchanges heat with outside air; and
a first additional cooling unit configured to supply a second cooling fluid to the first cooling target component and the second cooling target component,
wherein in a first situation, the first cooling fluid and the second cooling fluid cool the first cooling target component and the second cooling target component together.

2. The thermal management apparatus of claim 1, wherein the first additional cooling unit comprises:
a cooling cartridge configured to supply a second cooling fluid to the first cooling target component or the second cooling target component;
a first supply path which includes one end connected to the cooling cartridge and another end facing the first cooling target component and through which the second cooling fluid flows; and
a second supply path which includes one end connected to the cooling cartridge and another end facing the second cooling target component and through which the second cooling fluid flows.

3. The thermal management apparatus of claim 2, further comprising:
a controller configured to control an operation of the thermal management apparatus;
a first opening/closing unit arranged on the first supply path; and
a second opening/closing unit arranged on the second supply path,
wherein the controller controls flow of the second cooling fluid by operating the first opening/closing unit and the second opening/closing unit.

4. The thermal management apparatus of claim 1, wherein the first additional cooling unit comprises a recovery cartridge into which the second cooling fluid having passed through the first cooling target component or the second cooling target component is introduced and stored.

5. A thermal management apparatus for an electric propulsion aircraft, the thermal management apparatus comprising:
a first cooling channel configured to receive heat from a first cooling target component;
a second cooling channel configured to receive heat from a second cooling target component;
a heat exchanger in which a first cooling fluid having passed through the first cooling channel and the second cooling channel exchanges heat with outside air; and
a second additional cooling unit configured to supply a third cooling fluid to the first cooling target component and the second cooling target component,
wherein in a first situation, the first cooling fluid and the third cooling fluid cool the first cooling target component and the second cooling target component together,
the second additional cooling unit is between a gas turbine engine and a fuel tank, and
the third cooling fluid comprises fuel used in the gas turbine engine.

6. The thermal management apparatus of claim 5, wherein the second additional cooling unit comprises:
a power generation flow path which includes one end connected to the fuel tank and another end connected to the gas turbine engine and through which the third cooling fluid flows; and
an additional cooling flow path which includes one end connected to the fuel tank and another end facing the first cooling target component and the second cooling target component and through which the third cooling fluid flows.

7. The thermal management apparatus of claim 6, further comprising:
a controller configured to control an operation of the thermal management apparatus;
a third opening/closing unit arranged on the power generation flow path; and
a fourth opening/closing unit arranged on the additional cooling flow path,
wherein the controller controls flow of the third cooling fluid by operating the third opening/closing unit and the fourth opening/closing unit.

8. The thermal management apparatus of claim 5, further comprising a first additional cooling unit configured to supply a second cooling fluid to the first cooling target component and the second cooling target component,
wherein in the first situation, the first cooling fluid, the second cooling fluid, and the third cooling fluid cool the first cooling target component and the second cooling target component together.

9. A thermal management apparatus for an electric propulsion aircraft, the thermal management apparatus comprising:
an air inhalation port configured to inhale air outside the electric propulsion aircraft into an inside thereof;
a first heat exchanger in which hydrogen supplied from a hydrogen tank and air supplied from the air inhalation port exchange heat with each other and which supplies, to a hydrogen using unit, hydrogen having completed heat exchange;
a cooling channel configured to receive heat from an electrical component; and
a second heat exchanger in which a first cooling fluid having passed through the cooling channel and air having completed heat exchange in the first heat exchanger exchange heat with each other.

10. The thermal management apparatus of claim 9, further comprising an air temperature measurement unit configured to measure an air temperature outside the electric propulsion aircraft.

11. The thermal management apparatus of claim 9, further comprising a component temperature measurement unit configured to measure a temperature of the electrical component.

12. The thermal management apparatus of claim 9, further comprising a first additional cooling unit configured to cool the electrical component by using a second cooling fluid.

13. The thermal management apparatus of claim 9, further comprising a second additional cooling unit configured to cool the electrical component by using a third cooling fluid,
wherein the second additional cooling unit is between a gas turbine engine and a fuel tank, and
the third cooling fluid comprises fuel used in the gas turbine engine.

14. A thermal management apparatus for an electric propulsion aircraft, the thermal management apparatus comprising:
a cooling channel configured to receive heat from an electrical component;
a heat exchanger in which a first cooling fluid having passed through the cooling channel exchanges heat with outside air;
an air inhalation port configured to inhale the outside air into an inside thereof and transmit the inhaled outside air to the heat exchanger; and
a dry ice cartridge which is arranged between the heat exchanger and the air inhalation port and through which air introduced through the air inhalation port passes.

15. The thermal management apparatus of claim 14, further comprising a cooling fluid temperature measurement unit configured to measure a temperature of a cooling fluid flowing through a cooling fluid circulation path connected to the heat exchanger.

16. The thermal management apparatus of claim 14, further comprising an air temperature measurement unit configured to measure an air temperature outside the electric propulsion aircraft.

17. The thermal management apparatus of claim 14, further comprising a first additional cooling unit configured to cool the electrical component by using a second cooling fluid.

18. The thermal management apparatus of claim 14, further comprising a second additional cooling unit configured to cool the electrical component by using a third cooling fluid,
wherein the second additional cooling unit is between a gas turbine engine and a fuel tank, and
the third cooling fluid comprises fuel used in the gas turbine engine.

19. The thermal management apparatus of claim 14, wherein the heat exchanger comprises:
a first heat exchanger in which hydrogen supplied from a hydrogen tank and air supplied from the air inhalation port exchange heat with each other and which supplies, to a hydrogen using unit, hydrogen having completed heat exchange; and
a second heat exchanger in which a first cooling fluid having passed through the cooling channel and air having completed heat exchange in the first heat exchanger exchange heat with each other.
